(19) United States
(12) Patent Application Publication
(10) Pub. No.: US 2015/0373456 A1
(43) Pub. Date: Dec. 24, 2015

(54) Torsion Diaphragm Apparatus

(71) Applicant: Knowles Electronics, LLC, Itasca, IL (US)

(72) Inventors: Paul C. Dayton, Wayne, IL (US); Shehab Albahri, Hanover Park, IL (US)

(21) Appl. No.: 14/729,657

(22) Filed: Jun. 3, 2015

Related U.S. Application Data
(60) Provisional application No. 62/014,415, filed on Jun. 19, 2014.

(51) Int. Cl. H04R 7/04; H04R 7/18; H04R 11/04

(52) U.S. Cl. CPC H04R 7/04; H04R 11/04; H04R 7/18

(57) ABSTRACT

A diaphragm assembly disposed in a receiver and includes a support structure. The support structure is generally rectangular and has a length that extends along a longitudinal axis. The support structure has a width that is generally perpendicular to the longitudinal axis. The length is greater than the width. The assembly includes a paddle and a membrane, and the membrane extends over and being supported by the support structure and paddle. A gap is disposed between the paddle and the support structure. A plurality of tabs extend across the gap and connecting the paddle and support structure. The tabs are located along the length of the support structure and extend outward from the longitudinal axis across the gap. The tabs move in a twisting motion and not bending motion as the paddle moves.

### CROSS REFERENCES TO RELATED APPLICATION

This patent claims benefit under 35 U.S.C. §119 (e) to U.S. Provisional Application No. 62/014,415 entitled “Torsion Diaphragm Apparatus” filed Jun. 19, 2014, the content of which is incorporated herein by reference in its entirety.

### TECHNICAL FIELD

This application relates to acoustic devices and, more specifically, to the diaphragms used by these devices.

### BACKGROUND OF THE INVENTION

Various types of acoustic devices have been used over the years. One example of an acoustic device is a receiver. For example, a receiver typically includes a coil, diaphragm, bobbin, stack, among other components and these components are housed within the receiver housing. Other types of acoustic devices may include other types of components. The motor typically includes a coil, a yoke, such as a stack and an armature, which together form a magnetic circuit.

As mentioned, the above approaches use a diaphragm. An electrical signal creates a changing magnetic field moves an armature. The armature moves a drive rod, which moves a diaphragm to produce sound that is presented to listener.

### BRIEF DESCRIPTION OF THE DRAWINGS

For a more complete understanding of the disclosure, reference should be made to the following detailed description and accompanying drawings wherein:

FIG. 1 comprises a side cutaway view of a receiver according to various embodiments of the present invention;

FIG. 2A comprises a top perspective view of a diaphragm apparatus according to various embodiments of the present invention;

FIG. 2B comprises a bottom perspective view of the diaphragm apparatus of FIG. 2A according to various embodiments of the present invention;

FIG. 2C comprises a top view of the diaphragm apparatus of FIGS. 2A-2B according to various embodiments of the present invention;

FIG. 2D comprises a side cut-away view of the diaphragm apparatus of FIGS. 2A-2C taken along axis A-A according to various embodiments of the present invention;

FIG. 2E comprises a close-up view of the diaphragm apparatus of FIGS. 2A-2D in region A according to various embodiments of the present invention;

FIG. 2F comprises a bottom view of the diaphragm apparatus of FIGS. 2A-2E according to various embodiments of the present invention;

FIGS. 3A-3F comprise various views of a diaphragm apparatus (the type of views corresponding to the type of views of FIGS. 2A-2E) according to various embodiments of the present invention;

FIGS. 4A-4F comprise various views of a diaphragm apparatus (the type of views corresponding to the type of views of FIGS. 2A-2E) according to various embodiments of the present invention;

FIGS. 5A-5F comprise various views of a diaphragm apparatus (the type of views corresponding to the type of views of FIGS. 2A-2E) according to various embodiments of the present invention;

FIGS. 6A-6F comprise various views of a diaphragm apparatus (the type of views corresponding to the type of views of FIGS. 2A-2E) according to various embodiments of the present invention;

FIGS. 7A-7F comprise various views of a diaphragm apparatus (the type of views corresponding to the type of views of FIGS. 2A-2E) according to various embodiments of the present invention;

FIGS. 8A-8F comprise various views of a diaphragm apparatus (the type of views corresponding to the type of views of FIGS. 2A-2E) according to various embodiments of the present invention;

FIGS. 9A-9F comprise various views of a diaphragm apparatus (the type of views corresponding to the type of views of FIGS. 2A-2E) according to various embodiments of the present invention;

FIGS. 10A-10F comprise various views of a diaphragm apparatus (the type of views corresponding to the type of views of FIGS. 2A-2E) according to various embodiments of the present invention;

FIGS. 11A-11F comprise various views of a diaphragm apparatus (the type of views corresponding to the type of views of FIGS. 2A-2E) according to various embodiments of the present invention;

FIGS. 12A-12F comprise various views of a diaphragm apparatus (the type of views corresponding to the type of views of FIGS. 2A-2E) according to various embodiments of the present invention;

FIGS. 13A-13F comprise various views of a diaphragm apparatus (the type of views corresponding to the type of views of FIGS. 2A-2E) according to various embodiments of the present invention;

FIGS. 14A-14F comprise various views of a diaphragm apparatus (the type of views corresponding to the type of views of FIGS. 2A-2E) according to various embodiments of the present invention;

FIGS. 15A-15F comprise various views of a diaphragm apparatus (the type of views corresponding to the type of views of FIGS. 2A-2E) according to various embodiments of the present invention;

FIGS. 16A-16F comprise various views of a diaphragm apparatus (the type of views corresponding to the type of views of FIGS. 2A-2E) according to various embodiments of the present invention;

FIGS. 17A-17F comprise various views of a diaphragm apparatus (the type of views corresponding to the type of views of FIGS. 2A-2E) according to various embodiments of the present invention;

FIGS. 18A-18F comprise various views of a diaphragm apparatus (the type of views corresponding to the type of views of FIGS. 2A-2E) according to various embodiments of the present invention;

FIGS. 19A-19F comprise various views of a diaphragm apparatus (the type of views corresponding to the type of views of FIGS. 2A-2E) according to various embodiments of the present invention;

FIGS. 20A-20F comprise various views of a diaphragm apparatus (the type of views corresponding to the type of views of FIGS. 2A-2E) according to various embodiments of the present invention;

FIGS. 21A-21F comprise various views of a diaphragm apparatus (the type of views corresponding to the type of views of FIGS. 2A-2E) according to various embodiments of the present invention;

FIGS. 22A-22F comprise various views of a diaphragm apparatus (the type of views corresponding to the type of views of FIGS. 2A-2E) according to various embodiments of the present invention;

FIGS. 23A-23F comprise various views of a diaphragm apparatus (the type of views corresponding to the type of views of FIGS. 2A-2E) according to various embodiments of the present invention;

FIGS. 24A-24F comprise various views of a diaphragm apparatus (the type of views corresponding to the type of views of FIGS. 2A-2E) according to various embodiments of the present invention;

FIGS. 25A-25F comprise various views of a diaphragm apparatus (the type of views corresponding to the type of views of FIGS. 2A-2E) according to various embodiments of the present invention;

FIGS. 26A-26F comprise various views of a diaphragm apparatus (the type of views corresponding to the type of views of FIGS. 2A-2E) according to various embodiments of the present invention;

FIGS. 27A-27F comprise various views of a diaphragm apparatus (the type of views corresponding to the type of views of FIGS. 2A-2E) according to various embodiments of the present invention;

FIGS. 28A-28F comprise various views of a diaphragm apparatus (the type of views corresponding to the type of views of FIGS. 2A-2E) according to various embodiments of the present invention;

FIGS. 29A-29F comprise various views of a diaphragm apparatus (the type of views corresponding to the type of views of FIGS. 2A-2E) according to various embodiments of the present invention;

FIGS. 30A-30F comprise various views of a diaphragm apparatus (the type of views corresponding to the type of views of FIGS. 2A-2E) according to various embodiments of the present invention;

FIGS. 31A-31F comprise various views of a diaphragm apparatus (the type of views corresponding to the type of views of FIGS. 2A-2E) according to various embodiments of the present invention;

FIGS. 32A-32F comprise various views of a diaphragm apparatus (the type of views corresponding to the type of views of FIGS. 2A-2E) according to various embodiments of the present invention;

FIGS. 33A-33F comprise various views of a diaphragm apparatus (the type of views corresponding to the type of views of FIGS. 2A-2E) according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Approaches are described provides linearity of operation in the larger acoustic pressure ranges of acoustic devices. These approaches do not require additional process steps during manufacturing. The diaphragm assemblies provided herein do not approach stress geometric material non-linearities become significant.

In some of these embodiments, an acoustic device for use as a diaphragm or diaphragm assembly includes a support structure (ring), a membrane, a paddle, and tabs that are side tabs and not end tabs and that connect the paddle to the support structure. The acoustic device has a longer dimension with a longitudinal axis, and the tabs are located along this longer dimension outward from the longitudinal axis. The diaphragm could in other instances be square or even have a width that is wider than the length.

The diaphragm assembly serves the function in an Acoustic Receiver to divide the interior into a front cavity and a back cavity. The diaphragm assembly also moves the air such that sound is created.

In some aspects, a one piece diaphragm is used. In a one-piece diaphragm, the support ring and the paddle are part of a continuous structure. A single layer approach may also be used where the ring and the paddle structure are a single layer.

In these examples, hinges are provided. Hinges are provided at the end of the paddle that the paddle rotates around during its mechanical operation. A drive rod hole is provided where this hole or opening in the paddle allows connection of a beam (drive rod) between the receiver motor and the diaphragm.

Torsional hinges are used in the approaches described herein. The torsional action is where the paddle is hinged to the ring such that motion in the paddle causes a torsional twisting of the members bridging the paddle to the ring.

As used herein, the term “annulus” refers to a geometric form in the film that bridges the paddle and the ring to allow compliant motion of the paddle and at the same time maintains a seal between the front and back cavities. In one aspect, and s-annulus is used. In an s-annulus, the geometry between the paddle and ring takes on an S shape.

In some examples, a secondary paddle is included where the secondary paddle is a small paddle structure in the primary paddle that will resonate at a frequency different from the primary paddle.

In some aspects, a mesh is provided where the mesh is a pattern of small holes in the paddle that are used to adjust the mass of the paddle. The size of the holes are such that film bridging over the holes will not flex in the acoustic frequency range sufficiently to impact the output of the receiver.

In some aspects, a flexible membrane (annulus) where the flexible membrane is the thin film that forms the annulus. The ring is the outer structure of the diaphragm that support all other diaphragm components and is bonded to the receiver housing. The paddle is the moving portion of the diaphragm that generates the receiver sound.

The paddle stiffening member is a geometric feature in the paddle that creates a pre-determined stiffness in the paddle structure. The paddle stiffening member may be in many different forms. In one example, the paddle stiffening member is in the form of a hat: where the stiffening member that is a singular cup shape, rectangular in geometry. In another example, the paddle stiffening member is the form of a rib where one or more stiffening member that is long and narrow. In still another example, a dual layer diaphragm is used.

In some example, a secondary paddle flexible surround is provided. This is a film that surrounds the secondary paddle and is formed annulus like such that is allows the secondary paddle to move.

In many of these embodiments, a diaphragm assembly disposed in a receiver and includes a support structure. The support structure is generally rectangular and has a length that extends along a longitudinal axis. The support structure has a width that is generally perpendicular to the longitudinal axis. The length is greater than the width. The assembly includes a paddle and a membrane, and the membrane extends over and being supported by the support structure and paddle. A gap is disposed between the paddle and the support structure. A plurality of tabs extend across the gap and connecting the paddle and support structure. The tabs are located along the length of the support structure and extend outward from the longitudinal axis across the gap. The tabs move in a twisting motion and not bending motion as the paddle moves.

In other aspects, mesh openings extend through the paddle and these are configured to adjust the mass of the paddle. In other examples, the membrane is configured in an S-shaped cross section where the membrane extends across the gap.

In other examples, mesh openings extend through the paddle and these are configured to adjust the mass of the paddle. Additionally, the membrane is configured in an S-shaped cross section where the membrane extends across the gap.

In other aspects, the paddle and support structure are constructed of different materials. In still other examples, the paddle and the support structure are formed of multiple layers of materials. Additionally, mesh openings may also extend through the paddle and these are configured to adjust the mass of the paddle.

In still other examples, a secondary paddle is formed within the paddle. In other aspects, mesh openings extending through the secondary paddle and these are configured to adjust the mass of the secondary paddle. In yet other aspects, the membrane is configured in an S-shaped cross section where the membrane extends across the gap.

In some other examples, the membrane is configured in a U-shaped cross section where the membrane extends across the gap. In yet other examples, a diaphragm stiffening member is disposed on the paddle.

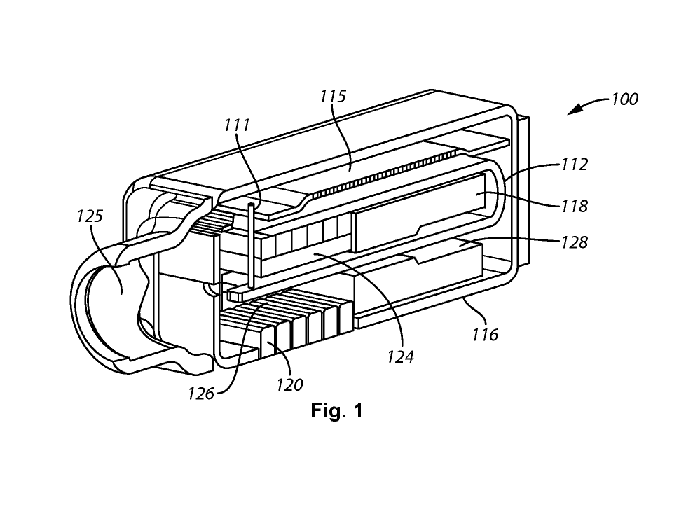

Referring now to FIG. 1, one example of a receiver 100 that uses the diaphragm assemblies described herein is described. The receiver 100 comprises a housing 114 defining an interior and an exterior. The receiver 100 further comprises a motor 116 including a coil 118, a yoke (or magnetic support structure) 120, and an armature 122 disposed substantially within the housing 114. Electric currents representing the sounds to be produced are moved through the coil 118. Current through the coil 118 displaces armature 122, which in turn displaces a drive pin 111, causing a diaphragm 115 to vibrate and create the desired sound. Sound exits through a port in the housing and then through a sound tube 125.

As mentioned, the motor 116 includes the armature 122, the coil 118, and the magnetic support structure 120. The motor 116 also includes at least one magnet 124 that defines a space 126. The coil 118 forms a tunnel 128. The space 126 is defined by the at least one magnet 124 being aligned with the tunnel 128 formed by the coil 118. Portions of the armature 122 extend through the space 126 and the tunnel 128.

Various aspects and variations of the present approaches are described below. For example, the diaphragm assembly has a first dimension (length) that is greater than a second dimension (width) or a third dimension (thickness). The hinges are torsional hinges are provided along the long direction (length) of the assembly and not on the ends. The hinges may be integral with an outer supporting member (or outer ring), integral with a central portion (paddle) and not the supporting member; or separate from both members. If not integral, the hinges may sit on top of the supporting member (or ring). Between the paddle and the ring, a space may exist and the membrane may in some examples form a u-shape extension over this space. In other examples, the membrane may form an s-shaped cross section in the space. The s-shaped cross section advantageously provides better compliance, less distortion, and better peak control for the receiver.

In other examples, a second paddle portion is provided at another end of the diaphragm assembly. In effect, one portion (associated with the hinges) moves at a first frequency while the second portion moves at a different frequency. In some other aspects, the mass of portions of the assembly may be adjusted using mesh holes. The use of these holes or openings can be used to alter the compliance of the diaphragm and the resonance frequency of the receiver.

The above-mentioned advantages apply to various ones of the examples described below.

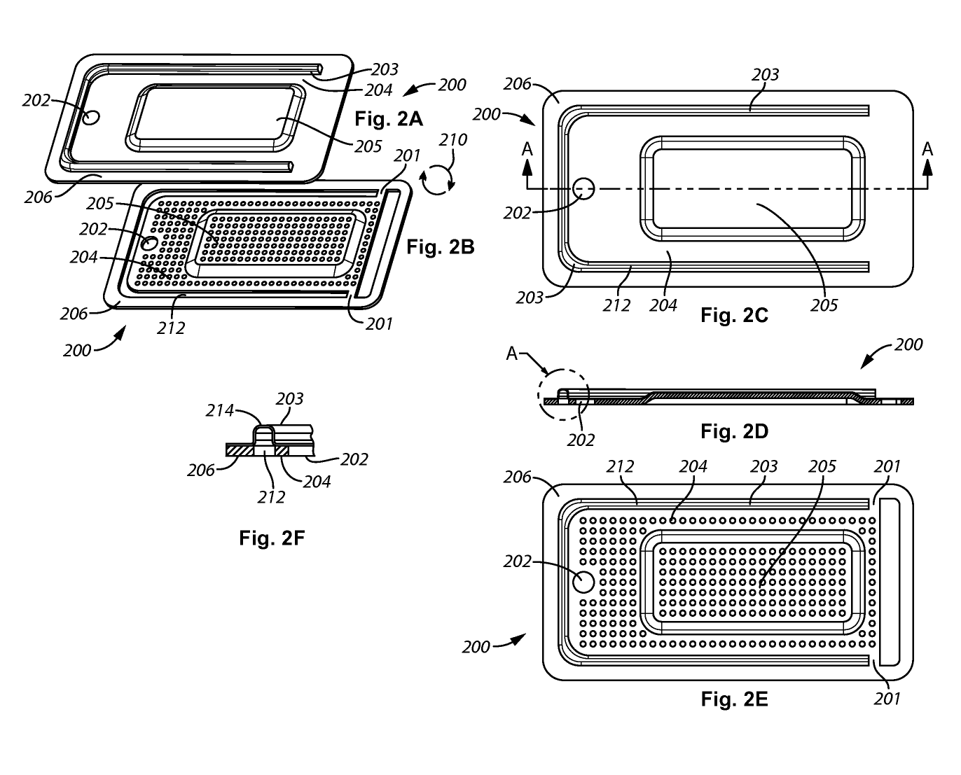

Referring now to FIGS. 2A-2F, one example of a diaphragm assembly 200 is described. The diaphragm assembly 200 includes torsional hinges 201, a drive rod opening or hole 202, a flexible membrane (annulus) 203, a paddle 204, a paddle stiffening member 205, and a support member 206. A gap 212 is formed between portions of the support member 206 and the paddle 204.

The torsional hinges 201 are configured as a side tab. In particular, the hinges 201 extend outwardly from the longitudinal axis A-A. As the paddle 204 moves, a twisting motion or force (shown by the arrow labeled 210) is created at the hinges 201. This action contrasts with a bending motion or force produced by cantilever approaches.

The drive rod hole 202 is configured to allow a drive rod (not shown in FIG. 2) to pass through. The drive rod is attached to the paddle 204. An electrical signal creates a changing magnetic field in the receiver and this causes the armature to move. The movement of the drive rod moves the paddle 204 and the membrane 203 moves. Sound is produced as the membrane 203 and paddle 204 moves.

The flexible membrane (annulus) 203 is constructed of, in one example, is a plastic film such as urethane, Mylar or silicone. Other examples are possible. The paddle 204 along with the support member 206 supports the membrane 203. The membrane 203 moves as the paddle 204.

The paddle stiffening member 205 is used for stiffening purposes. The reason for stiffening the paddle 204 is move air for the creation of sound. The support member 206 holds and supports the paddle.

As shown, the membrane 203 buckles upward over the top of the support member 206, across the gap 212, across the paddle 204, and across the stiffening member 205. A raised portion 214 of the membrane corresponds to the gap 212 and is created by a combination of pressure, vacuum, or heat onto a molded form.

The utilization of the torsional hinges 201 provides various advantages. For instance, positioning the torsional hinges 201 along the long side of the frame provide improved control of hinge stiffness and improves performance control and distribution with a mass-produced product (e.g., improves performance and quality of the product) compared to previous approaches. The positioning of the torsional hinges 201 also provides improved compliance without losing surface area compared with previous approaches. The torsional hinges 201 provide the ability to maintain maximum output at any desired compliance. The torsional hinges 201 additionally have reduced stress at the hinging element and improves long term life and reliability because they are stronger when positioned on the side than on the end. The torsional hinges 201 also improve shock performance under loading. The torsional hinges 201 furthermore reduce the risk of drift due to adhesives used on traditional cement bonded hinges since no glue is used.

With regards to compliance (deflection vs. force; for a given more deflection means a greater compliance), generally speaking in order to increase compliance of a diaphragm, the length of the hinging element is increased. In a cantilever design (hinges on the end not along the lengths), the surface area must be reduced to get compliance and this affects the area of the hinges. The torsional approach does not need to change the paddle area since the disposition of the side torsional hinges does not affect area (i.e., they are disposed on the side).

The torsional hinges 201 may be disposed at any angle as long as the hinges protrude from the side of the paddle 204. The torsional hinges 201 may also be used for primary diaphragm paddles and for any flexible coupling area. In some aspects, the configuration of the torsional hinges 201 on the flexible coupling area is selected to be significantly stiffer than the compliance of the primary diaphragm such that is has no independent motion until higher frequencies are achieved.

It will be appreciated that the advantages listed above are applicable for any of the torsional designs described herein.

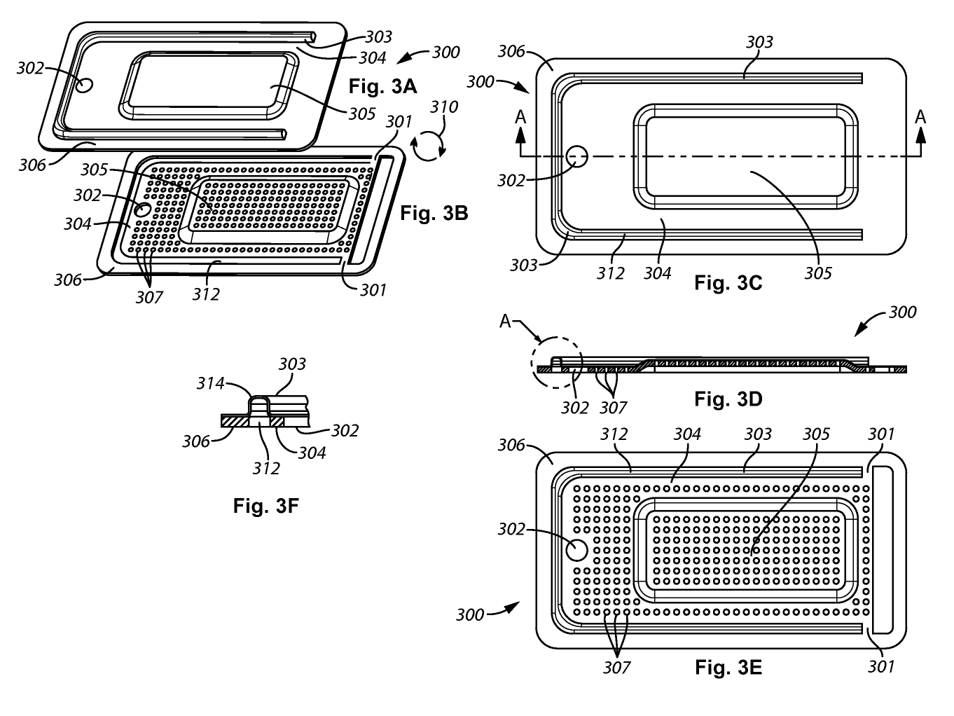

Referring now to FIGS. 3A-3F, another example of a diaphragm assembly 300 is described. The diaphragm assembly 300 includes torsional hinges 301, a drive rod opening or hole 302, a flexible membrane (annulus) 303, a paddle 304, a paddle stiffening member 305, and a support member 306. A gap 312 is formed between portions of the support member 306 and the paddle 304. These elements are similar to those described above with respect to the example of FIGS. 2A-F. The membrane 303 is raised at portion 313. The example of FIGS. 3A-3F is different in that the example of FIGS. 3A-3F includes mass adjusting mesh holes 307, which extend through the paddle 304. Using these holes, the mass of the paddle is adjusted to adjust performance.

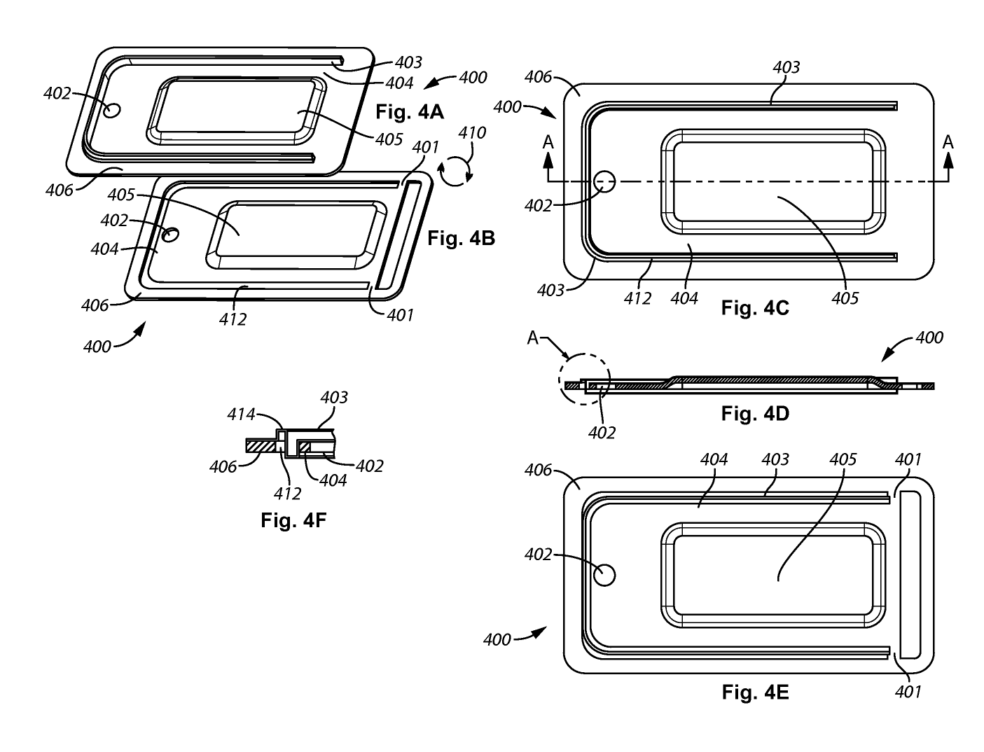

Referring now to FIGS. 4A-4F, another example of a diaphragm assembly 400 is described. The diaphragm assembly 400 includes torsional hinges 401, a drive rod opening or hole 402, a flexible membrane (annulus) 403, a paddle 404, a paddle stiffening member 405, and a support member 406. A gap 412 is formed between portions of the support member 406 and the paddle 404. These elements are similar to those described above with respect to the example of FIGS. 2A-F. The example of FIGS. 4A-4F is different from the above-mentioned examples in that the membrane is shaped as an “S” (in the cross section) in the gap 412. The portion 414 is the “S” shaped portion.

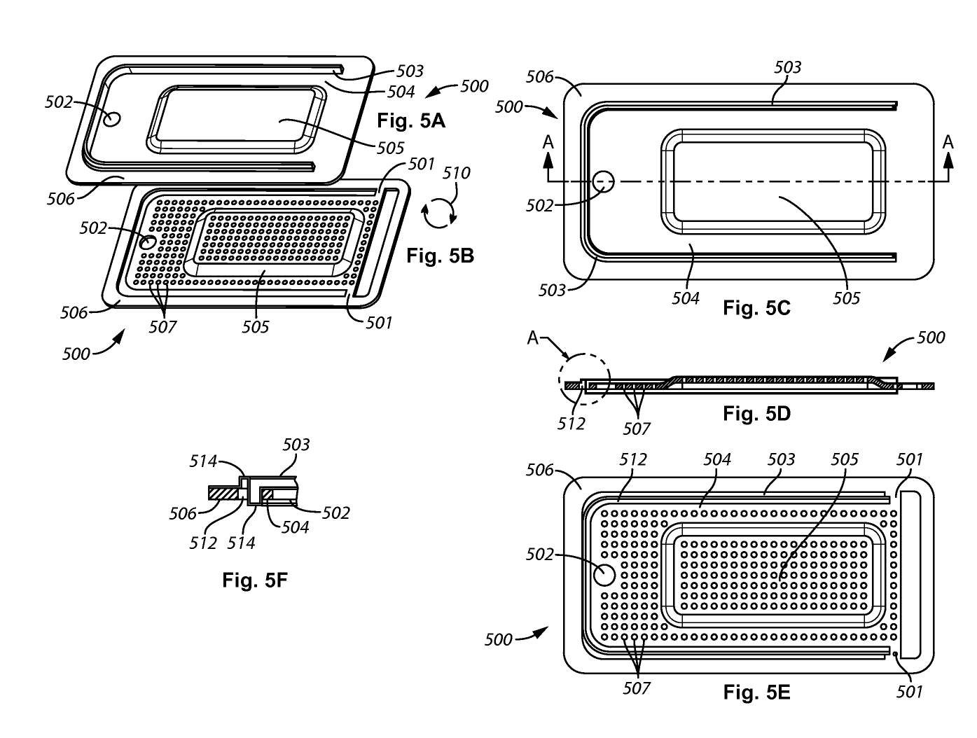

Referring now to FIGS. 5A-5F, another example of a diaphragm assembly 500 is described. The diaphragm assembly 500 includes torsional hinges 501, a drive rod opening or hole 502, a flexible membrane (annulus) 503, a paddle 504, a paddle stiffening member 505, and a support member 506. A gap 512 is formed between portions of the support member 506 and the paddle 504. These elements are similar to those described above with respect to the example of FIGS. 2A-F. The example of FIGS. 5A-5F is different in that the example of FIGS. 5A-F has mass adjusting mesh holes 507 and the membrane is shaped as an “S” (in the cross-section) in the gap 512. The portion 514 is the “S” shaped portion.

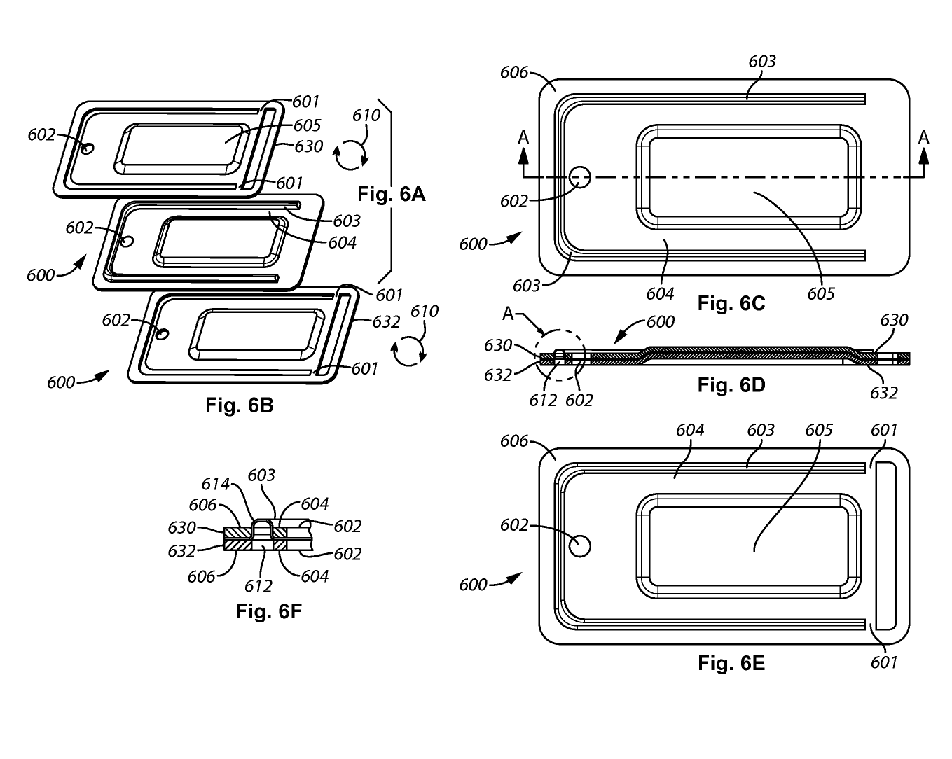

Referring now to FIGS. 6A-6F, another example of a diaphragm assembly 600 is described. The diaphragm assembly 600 includes torsional hinges 601, a drive rod opening or hole 602, a flexible membrane (annulus) 603, a paddle 604, a paddle stiffening member 605, and a support member 606. A gap 612 is formed between portions of the support member 606 and the paddle 604. These elements are similar to those described above with respect to the example of FIGS. 2A-F. The example of FIGS. 6A-6F is different in that the paddle 604 and the support member 606 are formed of a first layer 630 and a second layer 632. The materials used to form the layers 630 and 632 may be the same or different. A portion 614 is the extended portion of the membrane 603.

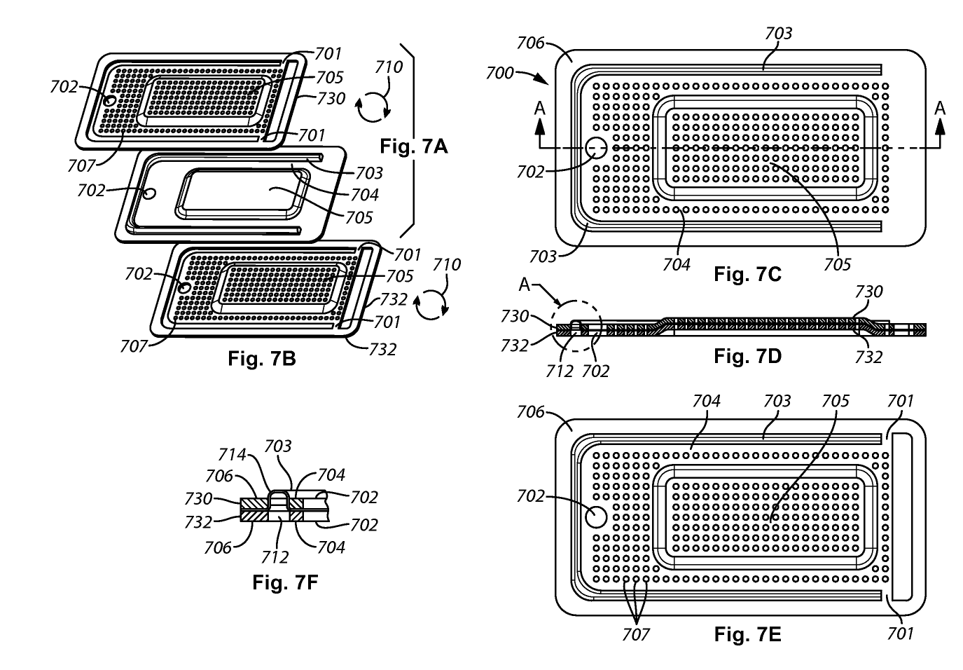

Referring now to FIGS. 7A-7F, another example of a diaphragm assembly 700 is described. The diaphragm assembly 700 includes torsional hinges 701, a drive rod opening or hole 702, a flexible membrane (annulus) 703, a paddle 704, a paddle stiffening member 705, and a support member 706. A gap 712 is formed between portions of the support member 706 and the paddle 704. These elements are similar to those described above with respect to the example of FIGS. 2A-F. The example of FIGS. 7A-7F is different from the example of FIGS. 6A-6F in that mesh holes are provided and extend through layers 730 and 732. A portion 714 is an extended portion of the membrane 703.

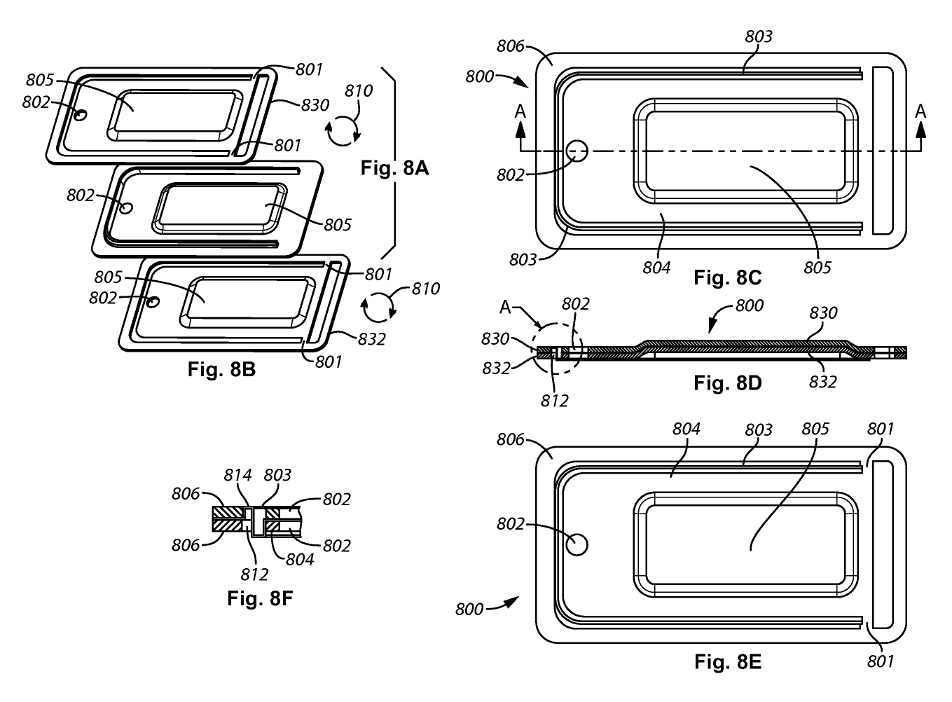

Referring now to FIGS. 8A-8F, another example of a diaphragm assembly 800 is described. The diaphragm assembly 800 includes torsional hinges 801, a drive rod opening or hole 802, a flexible membrane (annulus) 803, a paddle 804, a paddle stiffening member 805, and a support member 806. A gap 812 is formed between portions of the support member 806 and the paddle 804. These elements are similar to those described above with respect to the example of FIGS. 2A-F. The example of FIGS. 8A-8F is different from the example of FIGS. 7A-7F in that no mesh holes are provided and the membrane 803 has an S-shaped cross-sectional portion 814 in the opening 812.

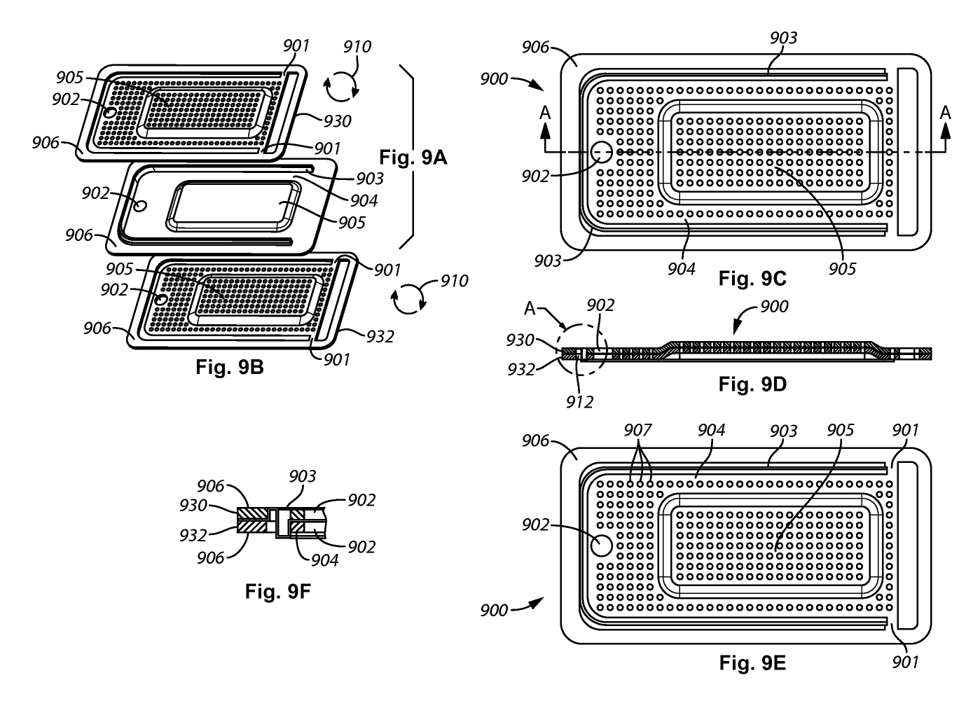

Referring now to FIGS. 9A-9F, another example of a diaphragm assembly 900 is described. The diaphragm assembly 900 includes torsional hinges 901, a drive rod opening or hole 902, a flexible membrane (annulus) 903, a paddle 904, a paddle stiffening member 905, and a support member 906. A gap 912 is formed between portions of the support member 906 and the paddle 904. These elements are similar to those described above with respect to the example of FIGS. 2A-F. The example of FIGS. 9A-9F is different from the example of FIGS. 8A-8F in that mesh holes 902 extend through layers 930 and 932. The membrane 903 has an S-shaped cross-sectional portion 914 in the opening 914.

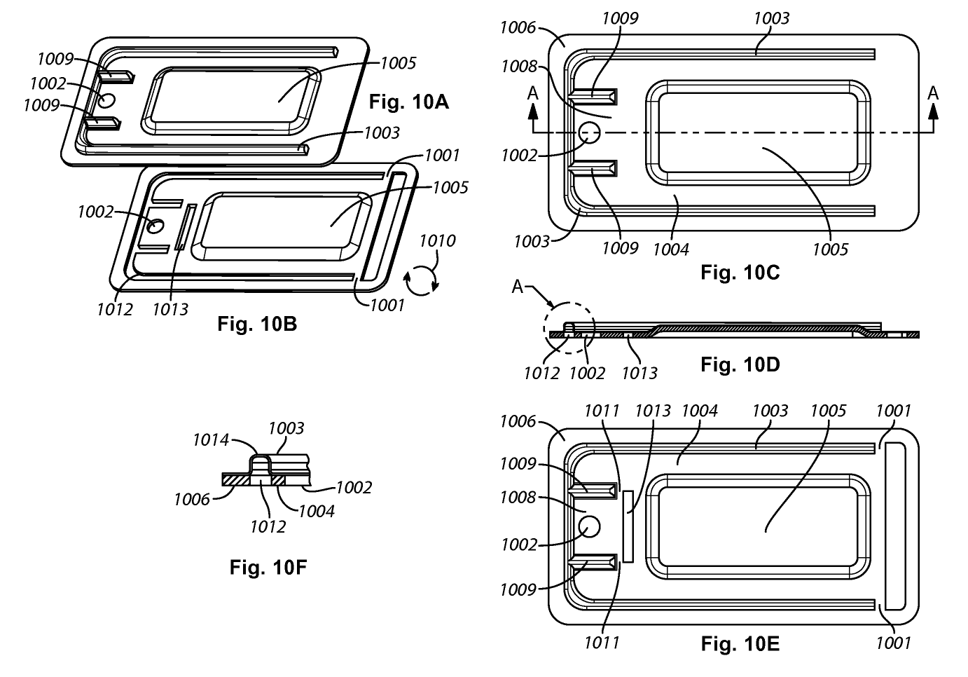

Referring now to FIGS. 10A-10F, another example of a diaphragm assembly 1000 is described. The diaphragm assembly 1000 includes torsional hinges 1001, a drive rod opening or hole 1002, a flexible membrane (annulus) 1003, a paddle 1004, a paddle stiffening member 1005, and a support member 1006. A gap 1012 is formed between portions of the support member 1006 and the paddle 1004. These elements are similar to those described above with respect to the example of FIGS. 2A-F. The example of FIGS. 10A-10F is different from the previous examples in that a secondary paddle area 1008 with a secondary paddle area flexible surround 1009 (and secondary hinges 1011) are provided. A secondary gap 1013 extends through the paddle 1004. The second paddle area 1008 may vibrate at a frequency that is different from the area associated with the hinges 1001.

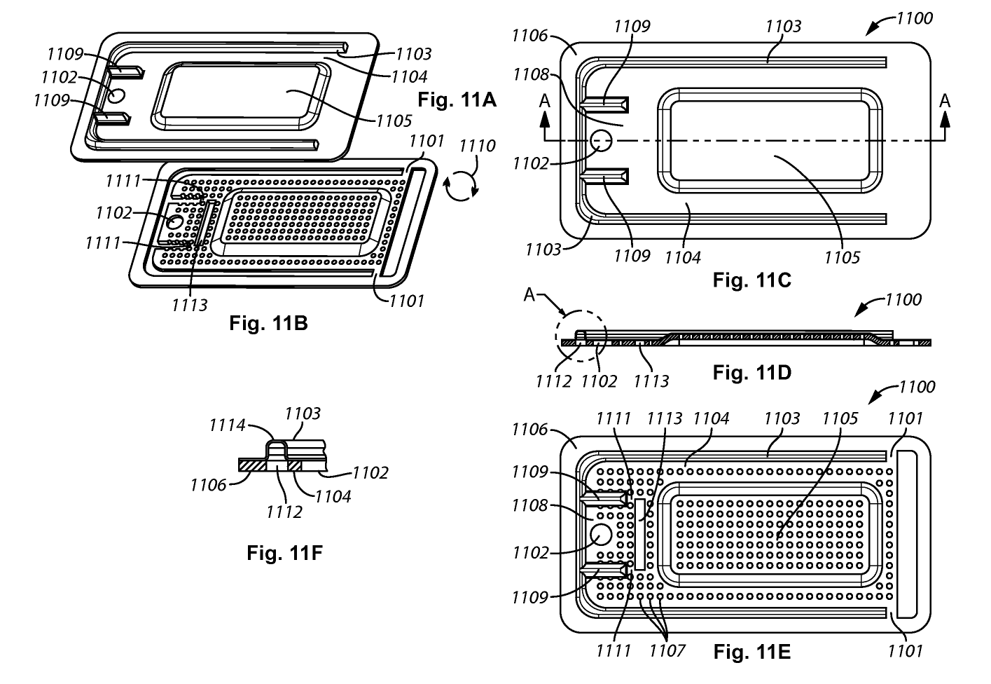

Referring now to FIGS. 11A-11F, another example of a diaphragm assembly 1100 is described. The diaphragm assembly 1100 includes torsional hinges 1101, a drive rod opening or hole 1102, a flexible membrane (annulus) 1103, a paddle 1104, a paddle stiffening member 1105, and a support member 1106. A gap 1112 is formed between portions of the support member 1106 and the paddle 1104. These elements are similar to those described above with respect to the example of FIGS. 2A-F. The example of FIGS. 11A-11F is different from the example of FIGS. 10A-10F in that mass adjusting mesh holes 1107 are provided through the paddle 1104. A secondary paddle area 1108 with a secondary paddle flexible surround 1109 (and secondary hinges 1111) are provided. A secondary gap 1113 extends through the paddle 1104.

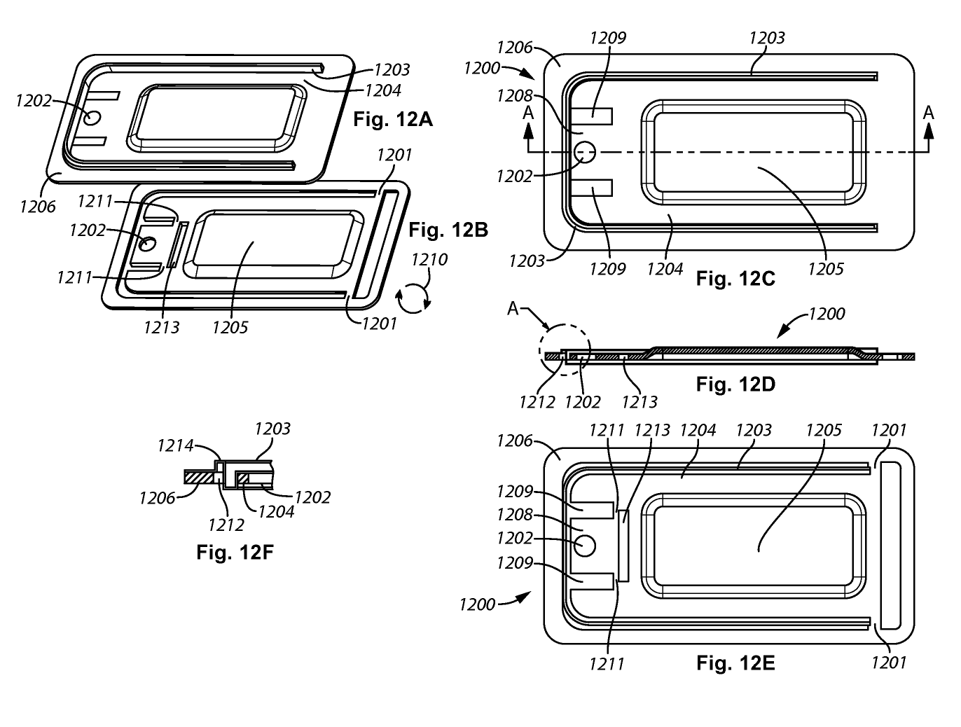

Referring now to FIGS. 12A-12F, another example of a diaphragm assembly 1200 is described. The diaphragm assembly 1200 includes torsional hinges 1201, a drive rod opening or hole 1202, a flexible membrane (annulus) 1203, a paddle 1204, a paddle stiffening member 1205, and a support member 1206. A gap 1212 is formed between portions of the support member 1206 and the paddle 1204. These elements are similar to those described above with respect to the example of FIGS. 2A-F. The example of FIGS. 12A-12F is different from the example of FIGS. 11A-11F in that the membrane 1203 is formed into an s-shaped cross-sectional portion 1214 in the gap 1212. A secondary paddle area 1208 with a secondary paddle flexible surround 1209 (and secondary hinges 1211) are provided.

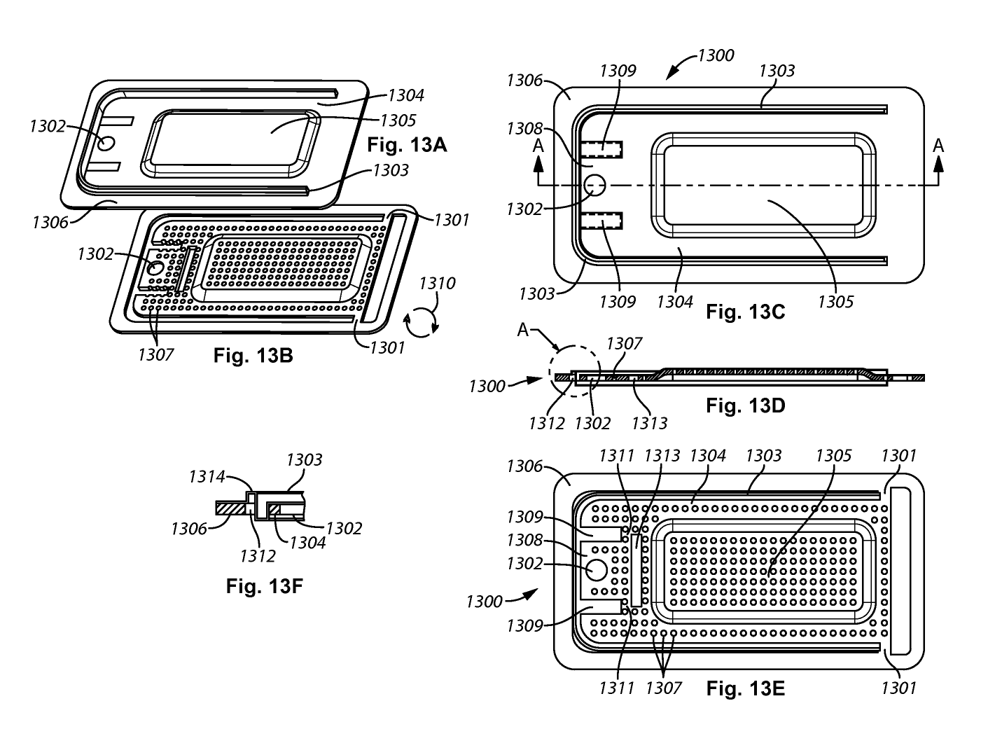

Referring now to FIGS. 13A-13F, another example of a diaphragm assembly 1300 is described. The diaphragm assembly 1300 includes torsional hinges 1301, a drive rod opening or hole 1302, a flexible membrane (annulus) 1303, a paddle 1304, a paddle stiffening member 1305, and a support member 1306. A gap 1312 is formed between portions of the support member 1306 and the paddle 1304. These elements are similar to those described above with respect to the example of FIGS. 2A-F. The example of FIGS. 13A-13F is different from the example of FIGS. 12A-12F in that mass adjusting mesh holes 1307 extend through the paddle 1304. The membrane 1303 is formed into an s-shaped cross-sectional portion 1314 in the gap 1312. A secondary paddle area 1308 with a secondary paddle flexible surround 1309 (and secondary hinges 1311) are provided.

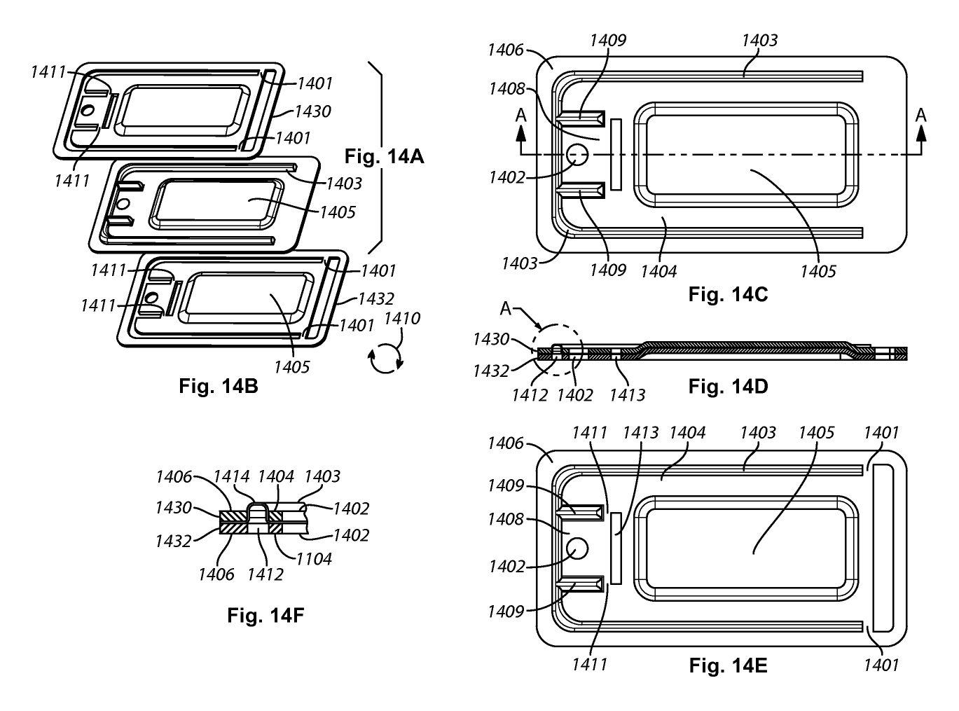

Referring now to FIGS. 14A-14F, another example of a diaphragm assembly 1400 is described. The diaphragm assembly 1400 includes torsional hinges 1401, a drive rod opening or hole 1402, a flexible membrane (annulus) 1403, a paddle 1404, a paddle stiffening member 1405, and a support member 1406. A gap 1412 is formed between portions of the support member 1406 and the paddle 1404. These elements are similar to those described above with respect to the example of FIGS. 2A-F. The example of FIGS. 14A-14F is different from the above examples of FIGS. 10-13 in that the paddle 1404 and the support member 1406 are constructed of a first layer 1430 and a second layer 1432. The membrane 1403 has a u-shaped extended portion 1414 in the gap 1412. A secondary paddle area 1408 with a secondary paddle flexible surround 1409 (and secondary hinges 1411) are provided.

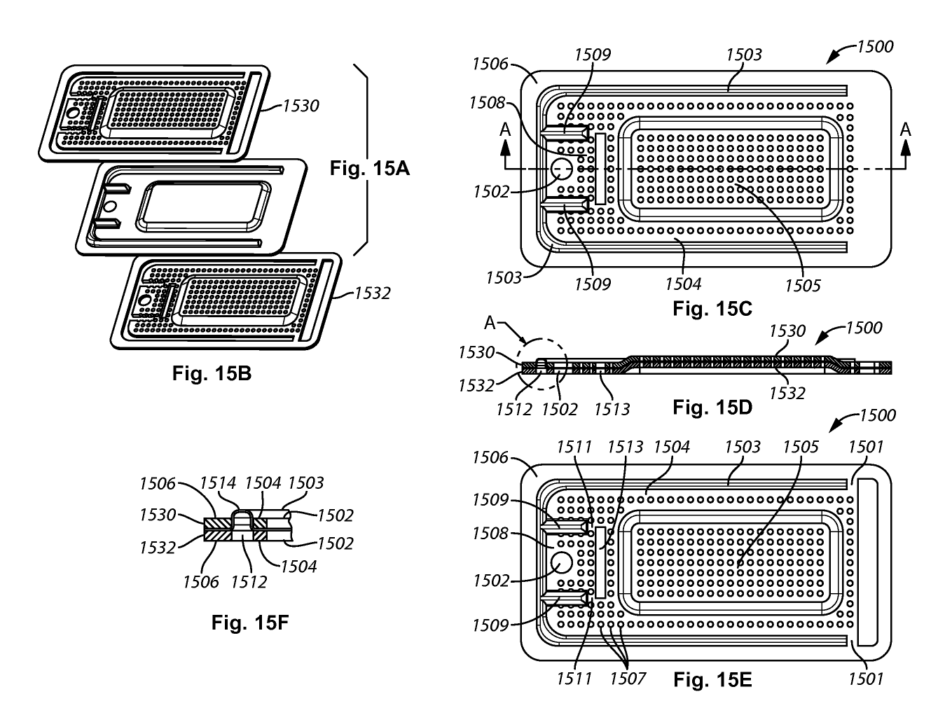

Referring now to FIGS. 15A-15F, another example of a diaphragm assembly 1500 is described. The diaphragm assembly 1500 includes torsional hinges 1501, a drive rod opening or hole 1502, a flexible membrane (annulus) 1503, a paddle 1504, a paddle stiffening member 1505, and a support member 1506. A gap 1512 is formed between portions of the support member 1506 and the paddle 1504. These elements are similar to those described above with respect to the example of FIGS. 2A-F. The example of FIGS. 15A-15F is different from the example of FIGS. 14A-14F in that mass adjusting mesh holes 1507 extends through layers 1530 and 1532 of the paddle 1504. The membrane 1503 has a u-shaped extended portion 1514 in the gap 1512. A secondary paddle area 1508 with a secondary paddle flexible surround 1509 (and secondary hinges 1511) is provided.

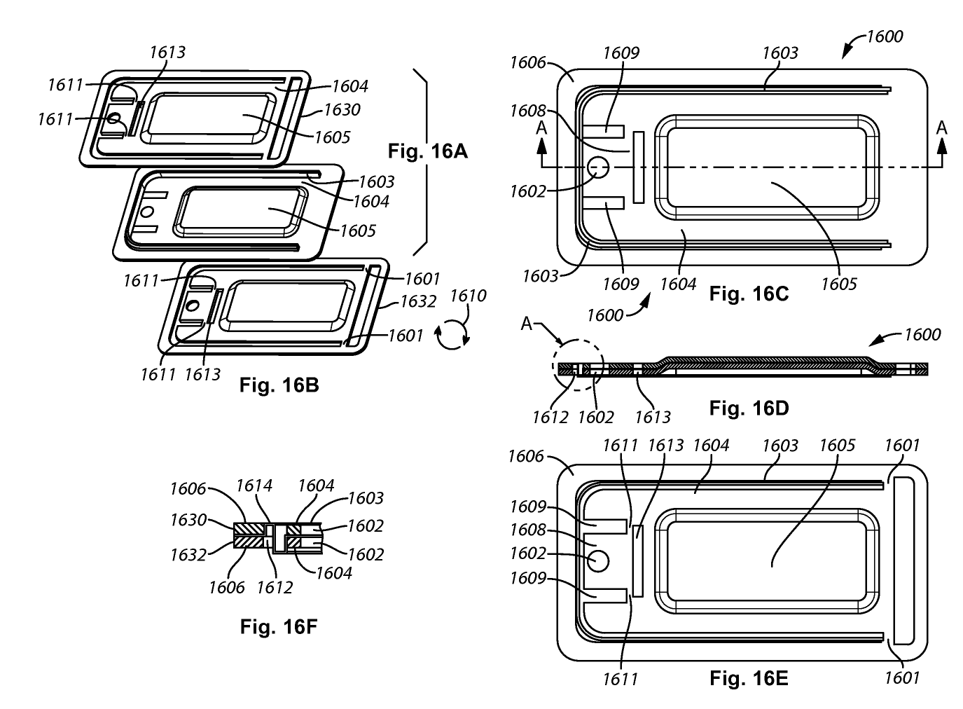

Referring now to FIGS. 16A-16F, another example of a diaphragm assembly 1600 is described. The diaphragm assembly 1600 includes torsional hinges 1601, a drive rod opening or hole 1602, a flexible membrane (annulus) 1603, a paddle 1604, a paddle stiffening member 1605, and a support member 1606. A gap 1612 is formed between portions of the support member 1606 and the paddle 1604. These elements are similar to those described above with respect to the example of FIGS. 2A-F. The example of FIGS. 16A-16F is different from the example of FIGS. 15A-15F in that no mass adjusting mesh holes exist and the membrane 1503 has an s-shaped portion 1614 in the gap 1612. A secondary paddle area 1608 with a secondary paddle flexible surround 1609 (and secondary hinges 1611) is provided.

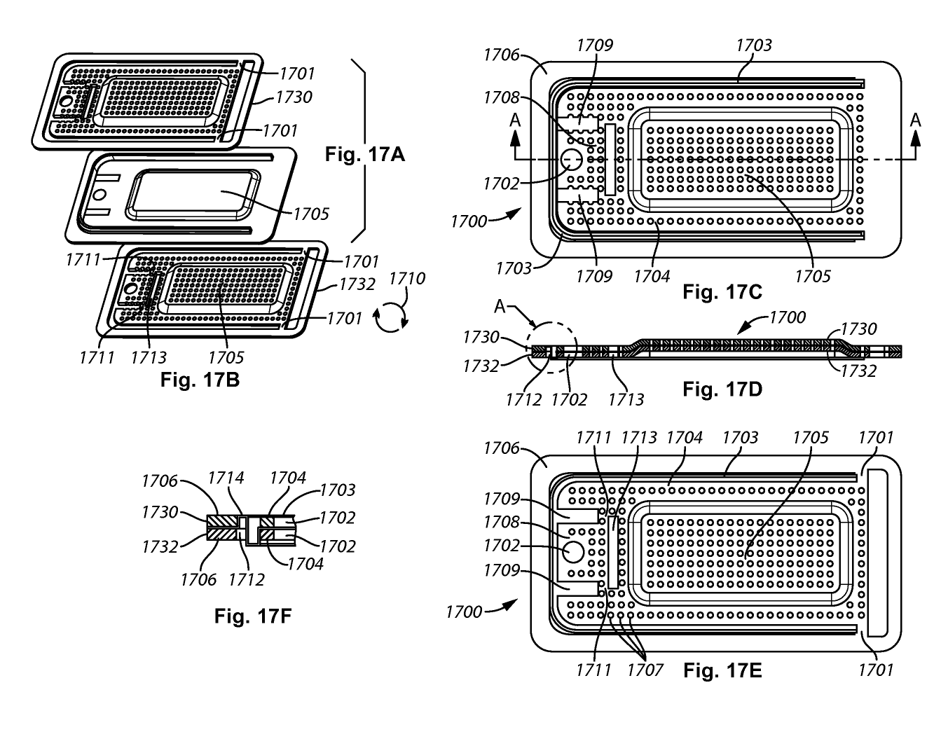

Referring now to FIGS. 17A-17F, another example of a diaphragm assembly 1700 is described. The diaphragm assembly 1700 includes torsional hinges 1701, a drive rod opening or hole 1702, a flexible membrane (annulus) 1703, a paddle 1704, a paddle stiffening member 1705, and a support member 1706. A gap 1712 is formed between portions of the support member 1706 and the paddle 1704. These elements are similar to those described above with respect to the example of FIGS. 2A-F. The example of FIGS. 17A-17F is different from the example of FIGS. 16A-16F in that mass adjusting mesh holes 1707 extend through layers 1730 and 1732 of the paddle 1704. The membrane 1703 has an s-shaped portion 1714 in the gap 1712. A secondary paddle area 1708 with a secondary paddle area 1708 with a secondary paddle flexible surround 1709 (and secondary hinges 1711) is provided.

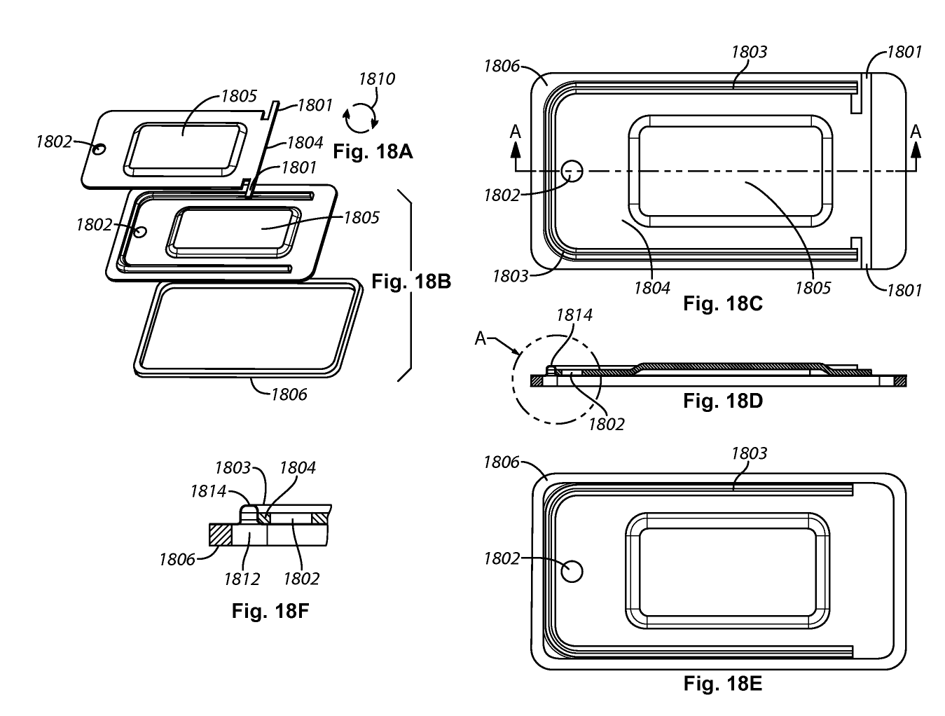

Referring now to FIGS. 18A-18F, another example of a diaphragm assembly 1800 is described. The diaphragm assembly 1800 includes torsional hinges 1801, a drive rod opening or hole 1802, a flexible membrane (annulus) 1803, a paddle 1804, a paddle stiffening member 1805, and a support member 1806. A gap 1812 is formed between portions of the support member 1806 and the paddle 1804. These elements are similar to those described above with respect to the example of FIGS. 2A-F. The example of FIGS. 18A-18F is different from the above-mentioned examples in that the paddle 1804 is disposed on the support member 1806 (which is now a ring-like element) and the hinges are formed as part of the paddle 1804 but not the support member 1806. The membrane 1803 has a u-shaped portion 1814 in the gap 1812.

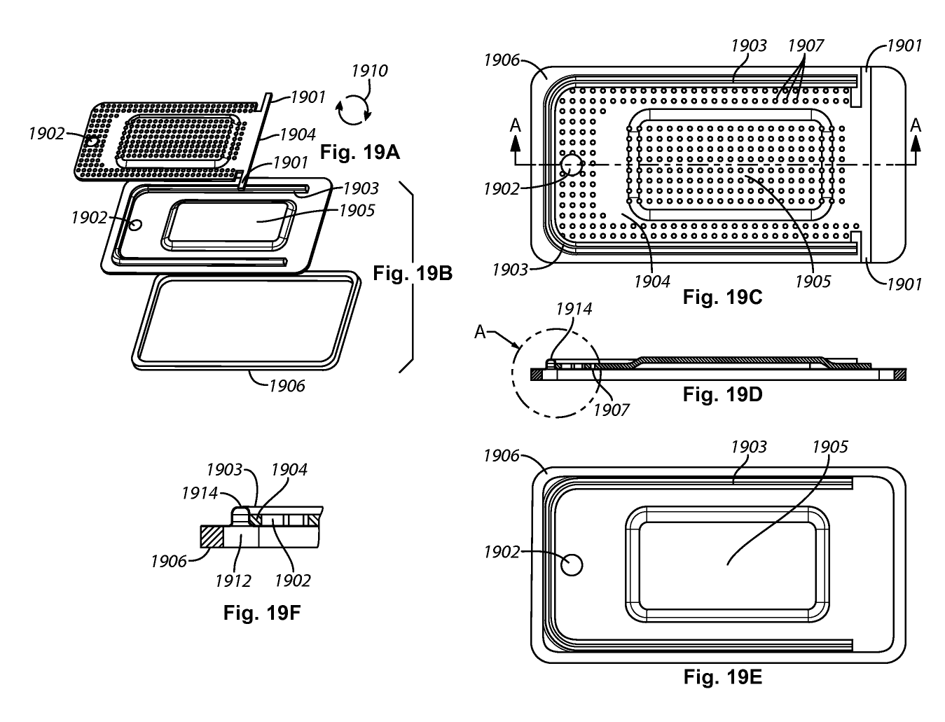

Referring now to FIGS. 19A-19F, another example of a diaphragm assembly 1900 is described. The diaphragm assembly 1900 includes torsional hinges 1901, a drive rod opening or hole 1902, a flexible membrane (annulus) 1903, a paddle 1904, a paddle stiffening member 1905, and a support member 1906. A gap 1912 is formed between portions of the support member 1906 and the paddle 1904. These elements are similar to those described above with respect to the example of FIGS. 2A-F. The example of FIGS. 19A-19F is different in that the paddle 1904 includes mass adjusting mesh holes 1907. The membrane 1903 has a u-shaped portion 1914 in the gap 1912.

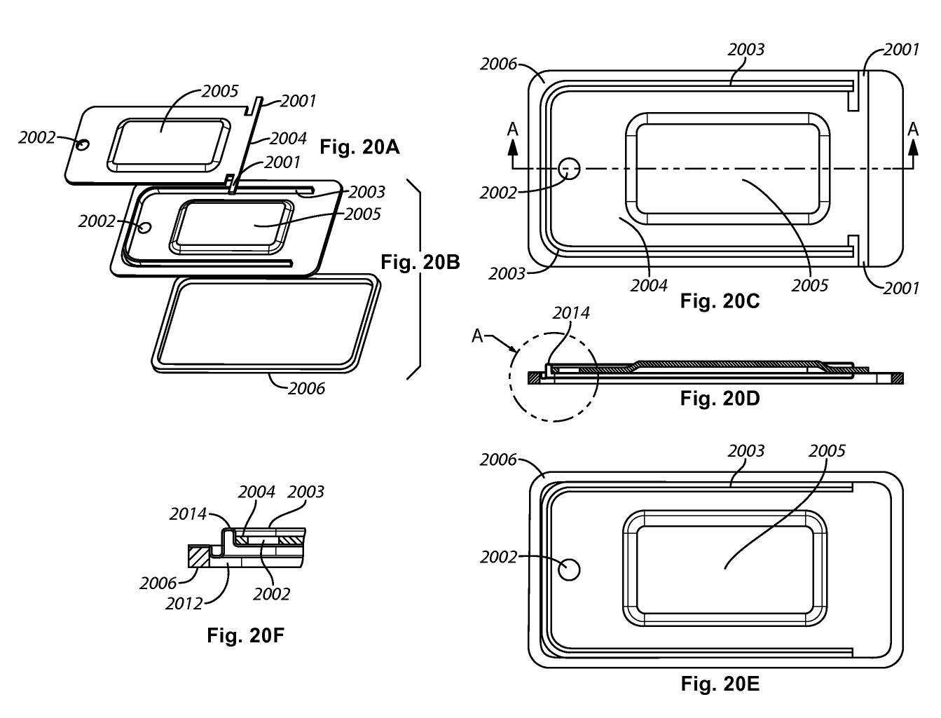

Referring now to FIGS. 20A-20F, another example of a diaphragm assembly 2000 is described. The diaphragm assembly 2000 includes torsional hinges 2001, a drive rod opening or hole 2002, a flexible membrane (annulus) 2003, a paddle 2004, a paddle stiffening member 2005, and a support member 2006. A gap 2012 is formed between portions of the support member 2006 and the paddle 2004. These elements are similar to those described above with respect to the example of FIGS. 2A-F. The example of FIGS. 20A-20F is different in that the membrane 2003 has an s-shaped portion 2014 in the gap 2012.

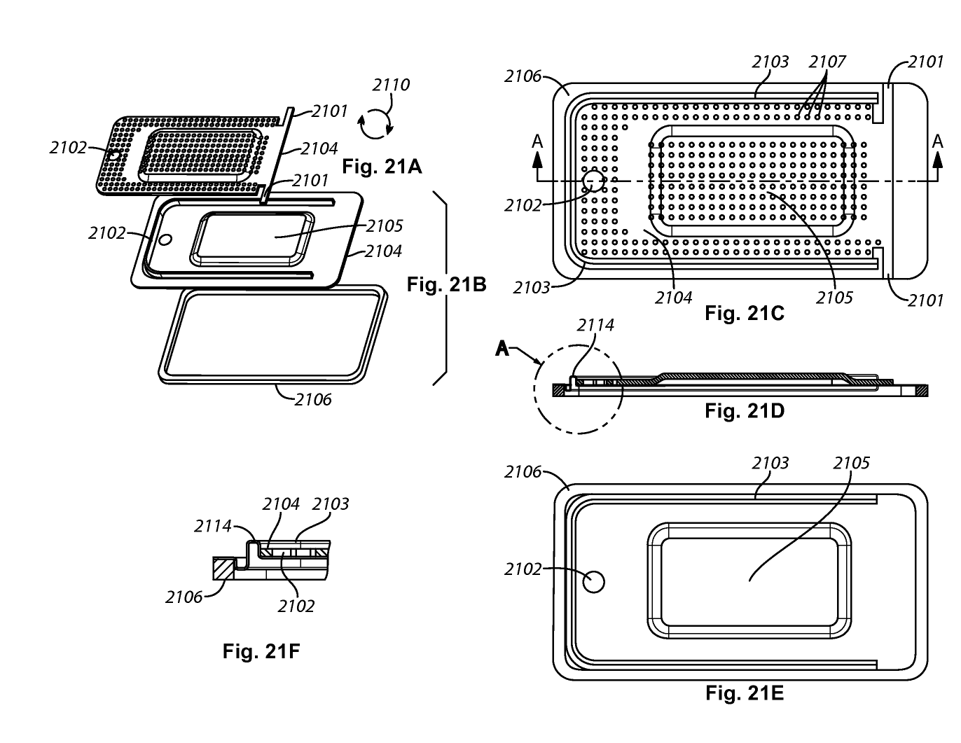

Referring now to FIGS. 21A-21F, another example of a diaphragm assembly 2100 is described. The diaphragm assembly 2100 includes torsional hinges 2101, a drive rod opening or hole 2102, a flexible membrane (annulus) 2103, a paddle 2104, a paddle stiffening member 2105, and a support member 2106. A gap 2112 is formed between portions of the support member 2106 and the paddle 2104. These elements are similar to those described above with respect to the example of FIGS. 2A-F. The example of FIGS. 21A-21F is different from the example of FIGS. 20A-F in that that the paddle 2104 includes mass adjusting mesh holes 2107.

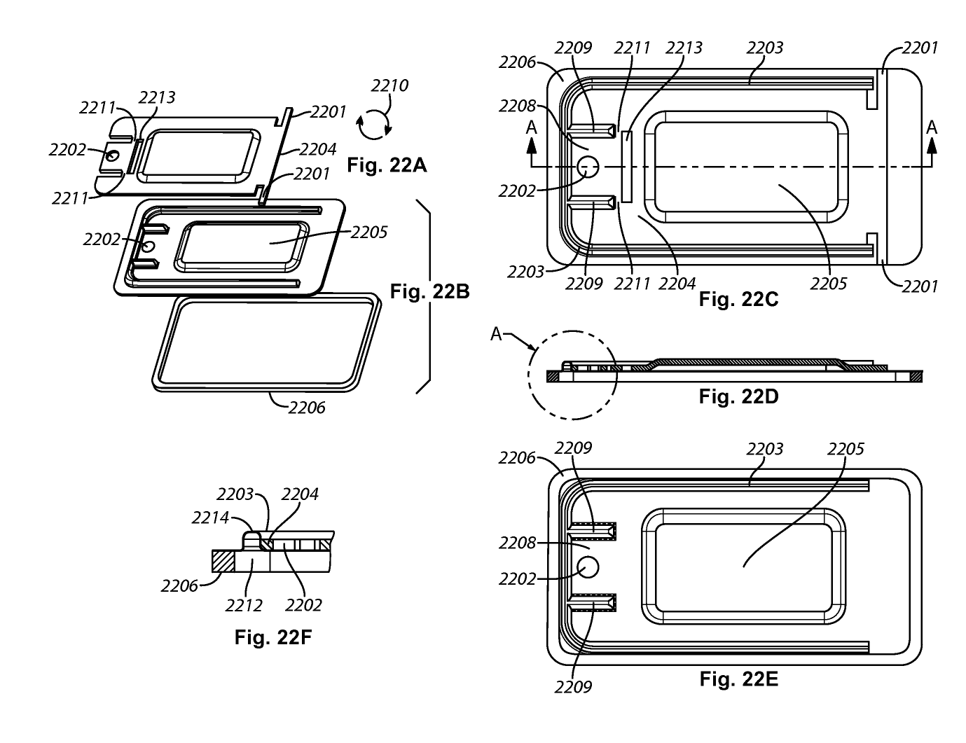

Referring now to FIGS. 22A-22F, another example of a diaphragm assembly 2200 is described. The diaphragm assembly 2200 includes torsional hinges 2201, a drive rod opening or hole 2202, a flexible membrane (annulus) 2203, a paddle 2204, a paddle stiffening member 2205, and a support member 2206. A gap 2212 is formed between portions of the support member 2206 and the paddle 2204. These elements are similar to those described above with respect to the example of FIGS. 2A-F. The example of FIGS. 22A-22F is different in that a secondary paddle area 2208 with a secondary paddle area flexible surround 2209 (and secondary hinges 2211) are provided. A secondary gap 2213 extends through the paddle 2204. The membrane 2203 has a u-shaped portion 2214 in the gap 2212.

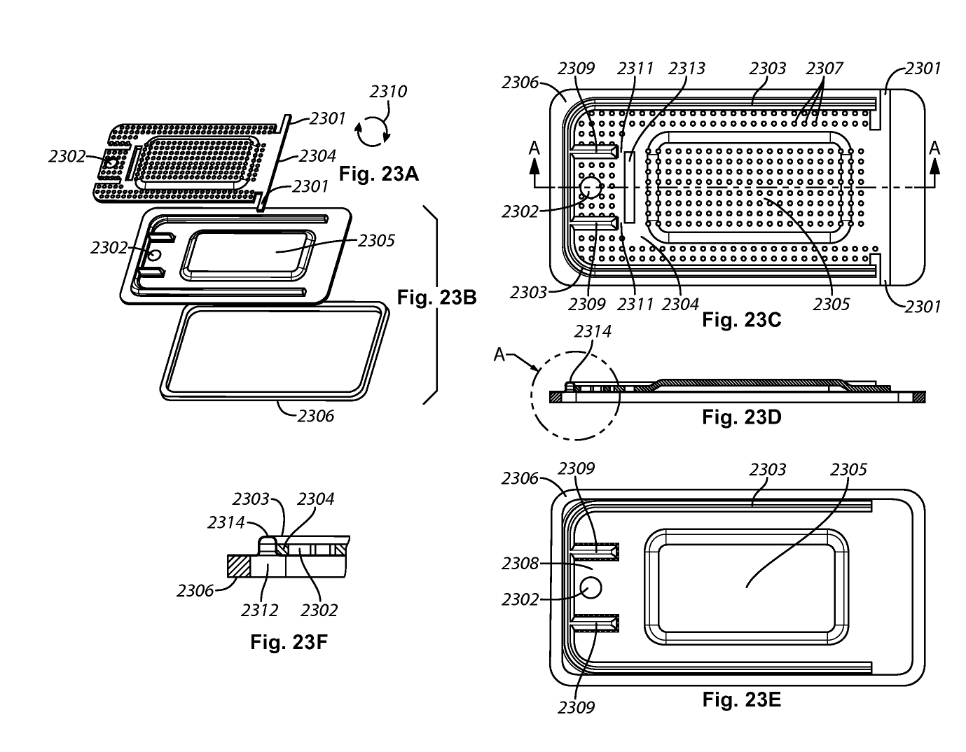

Referring now to FIGS. 23A-23F, another example of a diaphragm assembly 2300 is described. The diaphragm assembly 2300 includes torsional hinges 2301, a drive rod opening or hole 2302, a flexible membrane (annulus) 2303, a paddle 2304, a paddle stiffening member 2305, and a support member 2306. A gap 2312 is formed between portions of the support member 2306 and the paddle 2304. These elements are similar to those described above with respect to the example of FIGS. 2A-F. The example of FIGS. 23A-23F is different from the example of FIGS. 22A-F in that the paddle 2204 includes mass adjusting mesh holes 2207.

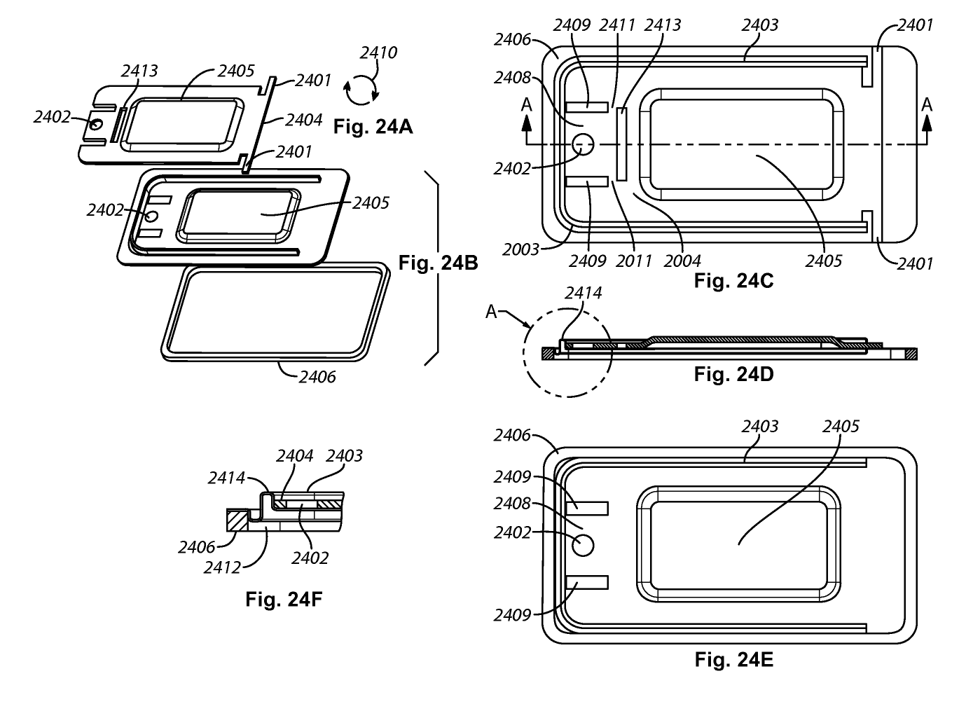

Referring now to FIGS. 24A-24F, another example of a diaphragm assembly 2400 is described. The diaphragm assembly 2400 includes torsional hinges 2401, a drive rod opening or hole 2402, a flexible membrane (annulus) 2403, a paddle 2404, a paddle stiffening member 2405, and a support member 2406. A gap 2412 is formed between portions of the support member 2406 and the paddle 2404. These elements are similar to those described above with respect to the example of FIGS. 2A-F. The example of FIGS. 24A-24F is different from the example of FIGS. 22A-F in that in the example of FIGS. 24A-F the membrane 2403 has an S-shaped portion 2414 in the gap 2412.

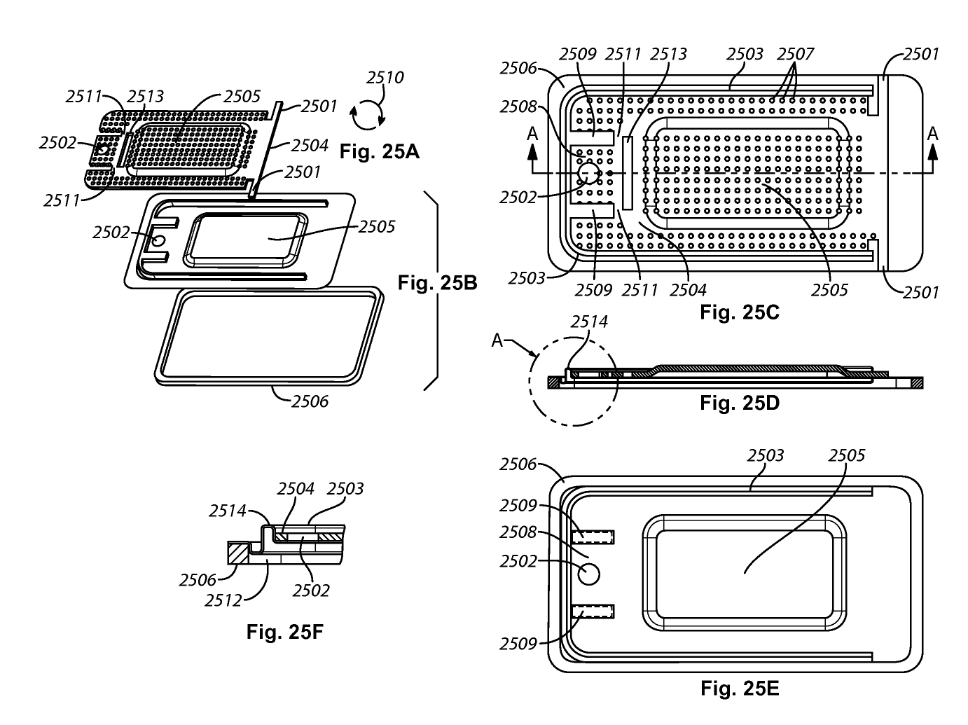

Referring now to FIGS. 25A-25F, another example of a diaphragm assembly 2500 is described. The diaphragm assembly 2500 includes torsional hinges 2501, a drive rod opening or hole 2502, a flexible membrane (annulus) 2503, a paddle 2504, a paddle stiffening member 2505, and a support member 2506. A gap 2512 is formed between portions of the support member 2506 and the paddle 2504. These elements are similar to those described above with respect to the example of FIGS. 2A-F. The example of FIGS. 25A-25F is different from the example of FIGS. 25A-F in that the paddle 2504 includes mass adjusting mesh holes 2507.

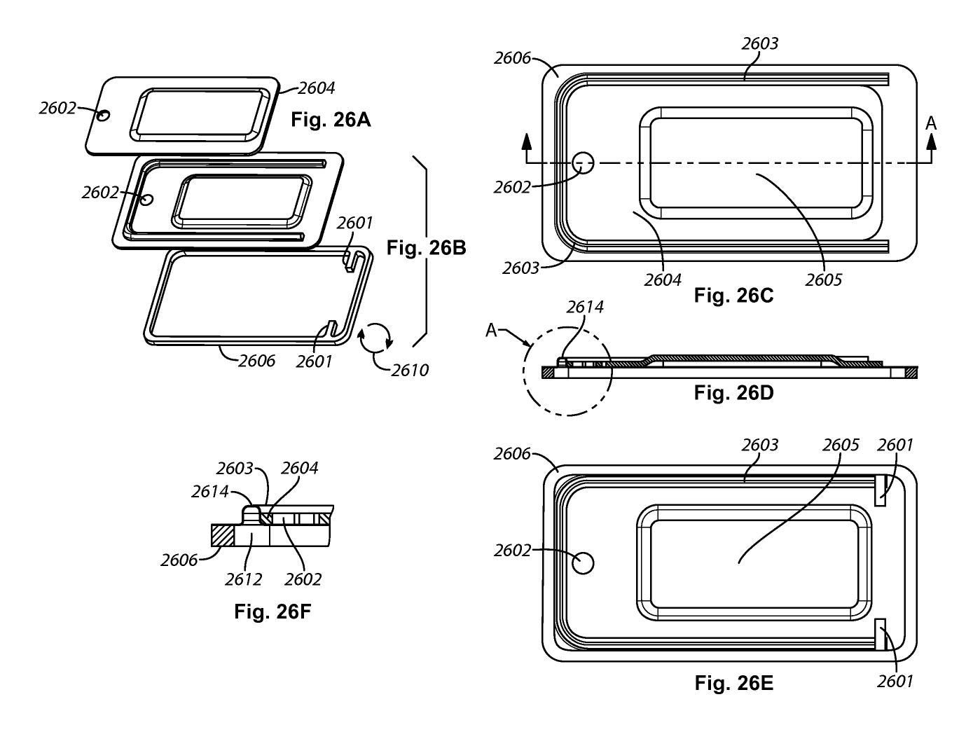

Referring now to FIGS. 26A-26F, another example of a diaphragm assembly 2600 is described. The diaphragm assembly 2600 includes torsional hinges 2601, a drive rod opening or hole 2602, a flexible membrane (annulus) 2603, a paddle 2604, a paddle stiffening member 2605, and a support member 2606. A gap 2612 is formed between portions of the support member 2606 and the paddle 2604. These elements are similar to those described above with respect to the example of FIGS. 2A-F. The example of FIGS. 26A-26F is different from the example of FIGS. 2A-F in that in the example of FIGS. 26A-F, the hinges 2601 are formed on the support member 2606. The membrane 2403 has a u-shaped portion 2414 in the gap 2412.

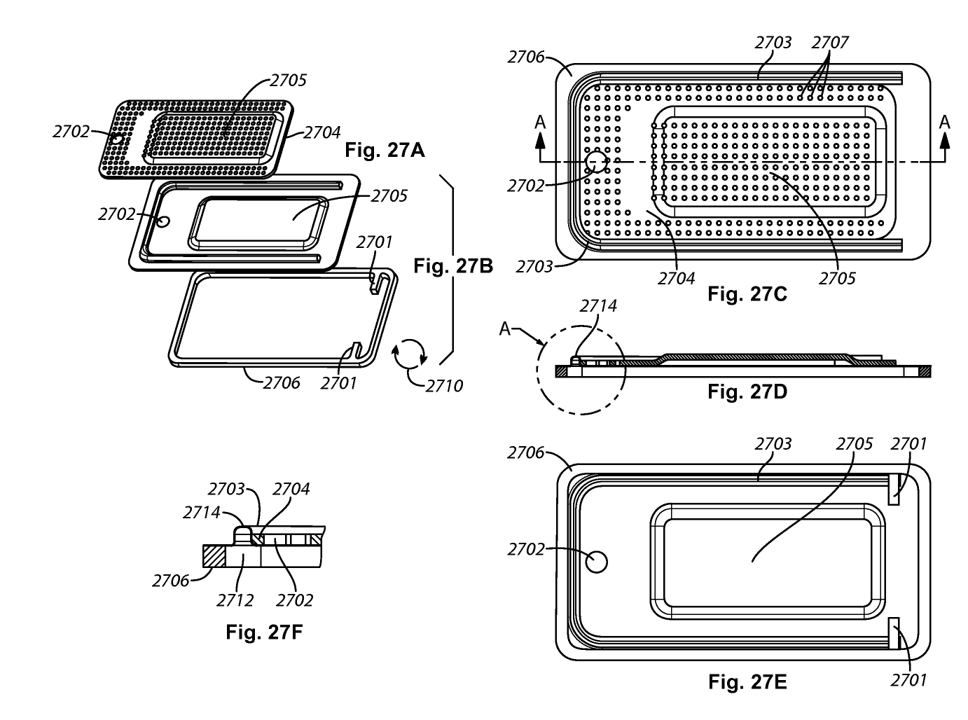

Referring now to FIGS. 27A-27F, another example of a diaphragm assembly 2700 is described. The diaphragm assembly 2700 includes torsional hinges 2701, a drive rod opening or hole 2702, a flexible membrane (annulus) 2703, a paddle 2704, a paddle stiffening member 2705, and a support member 2706. A gap 2712 is formed between portions of the support member 2706 and the paddle 2704. These elements are similar to those described above with respect to the example of FIGS. 2A-F. The example of FIGS. 27A-27F is different from the example of 26A-F in that in the example of FIGS. 27A-F the paddle 2704 includes mass adjusting mesh holes 2707.

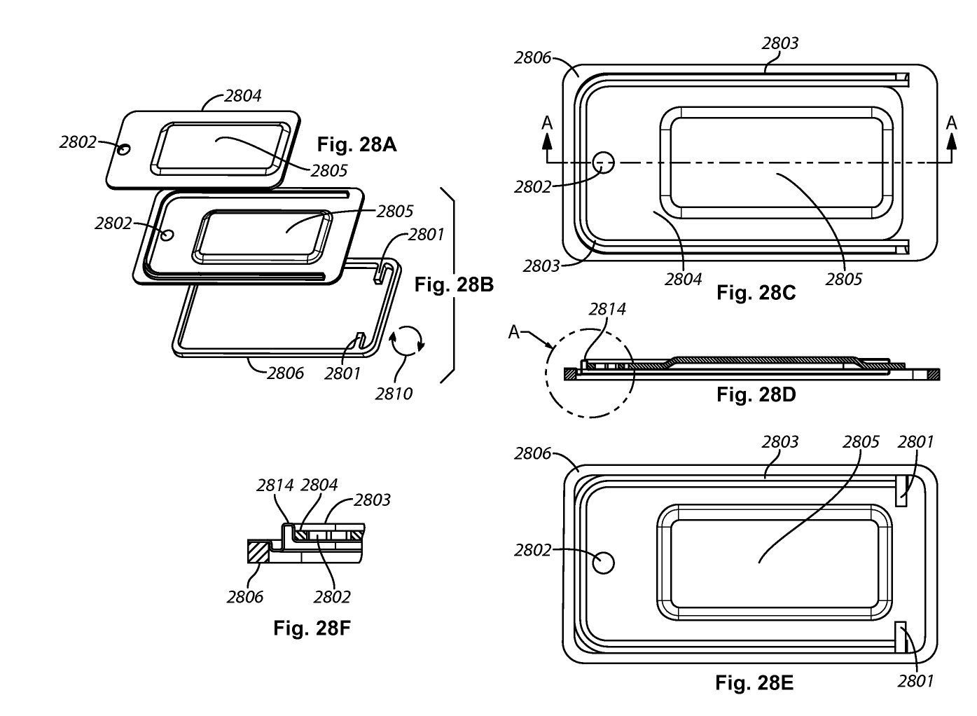

Referring now to FIGS. 28A-28F, another example of a diaphragm assembly 2800 is described. The diaphragm assembly 2800 includes torsional hinges 2801, a drive rod opening or hole 2802, a flexible membrane (annulus) 2803, a paddle 2804, a paddle stiffening member 2805, and a support member 2806. A gap 2812 is formed between portions of the support member 2806 and the paddle 2804. These elements are similar to those described above with respect to the example of FIGS. 2A-F. The example of FIGS. 28A-28F is different from the example of FIGS. 26A-F in that in the example of FIGS. 28A-F the membrane 2803 has an S-shaped portion 2814 in the gap 2812.

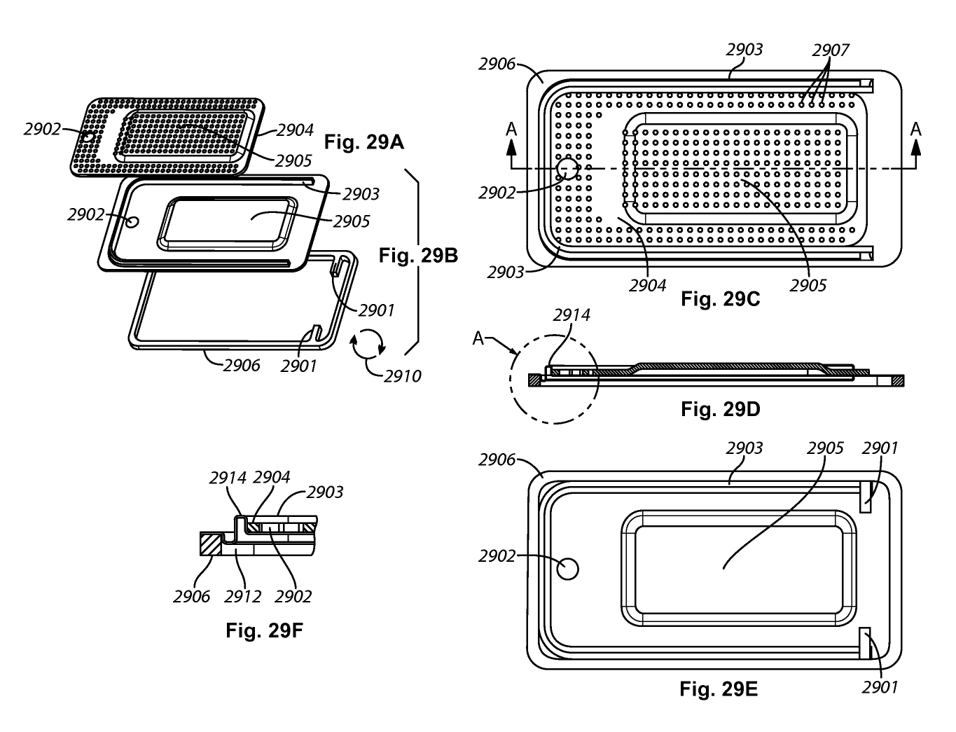

Referring now to FIGS. 29A-29F, another example of a diaphragm assembly 2900 is described. The diaphragm assembly 2900 includes torsional hinges 2901, a drive rod opening or hole 2902, a flexible membrane (annulus) 2903, a paddle 2904, a paddle stiffening member 2905, and a support member 2906. A gap 2912 is formed between portions of the support member 2906 and the paddle 2904. These elements are similar to those described above with respect to the example of FIGS. 2A-F. The example of FIGS. 29A-29F is different from the example of FIGS. 28A-F in that in the example of FIGS. 29A-F the paddle 2904 includes mass adjusting mesh holes 2907.

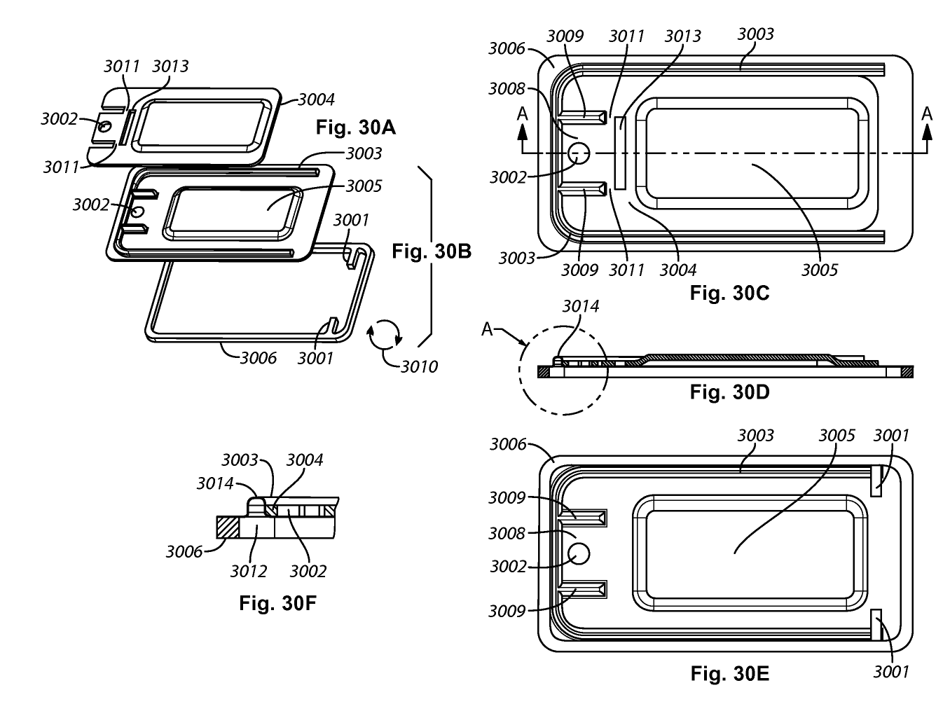

Referring now to FIGS. 30A-30F, another example of a diaphragm assembly 3000 is described. The diaphragm assembly 3000 includes torsional hinges 3001, a drive rod opening or hole 3002, a flexible membrane (annulus) 3003, a paddle 3004, a paddle stiffening member 3005, and a support member 3006. A gap 3012 is formed between portions of the support member 3006 and the paddle 3004. These elements are similar to those described above with respect to the example of FIGS. 2A-F. The example of FIGS. 30A-30F is different in that a secondary paddle area 3008 with a secondary paddle area flexible surround 3009 (and secondary hinges 3011) are provided. A secondary gap 3013 extends through the paddle 3004. The membrane 3003 has a u-shaped portion 3014 in the gap 3012.

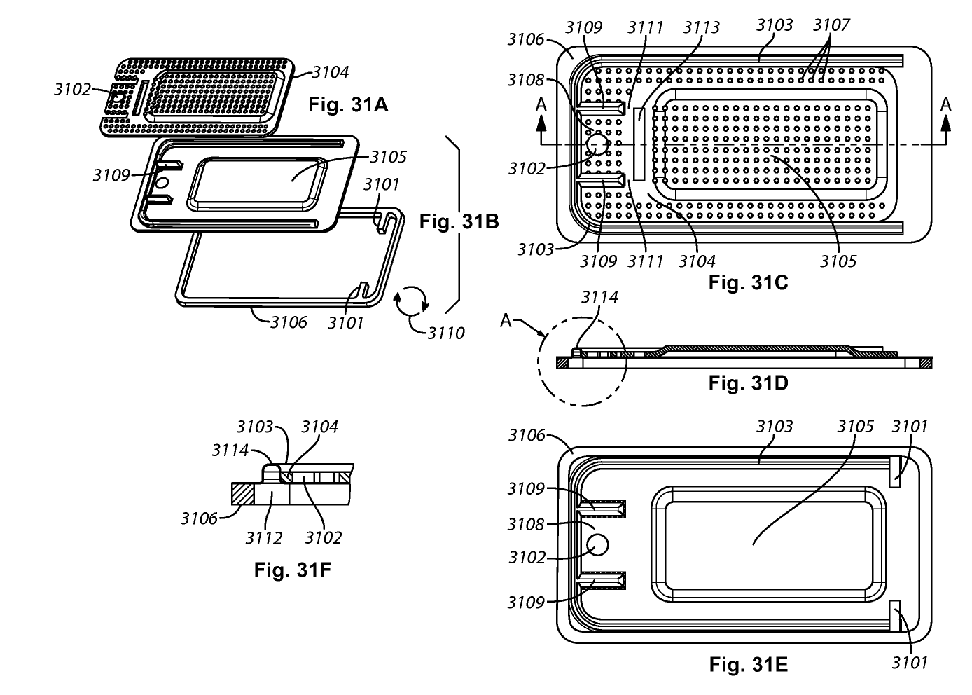

Referring now to FIGS. 31A-31F, another example of a diaphragm assembly 3100 is described. The diaphragm assembly 3100 includes torsional hinges 3101, a drive rod opening or hole 3102, a flexible membrane (annulus) 3103, a paddle 3104, a paddle stiffening member 3105, and a support member 3106. A gap 3112 is formed between portions of the support member 3106 and the paddle 3104. These elements are similar to those described above with respect to the example of FIGS. 2A-F. The example of FIGS. 31A-31F is different from the example of FIGS. 30A-F in that the paddle 3104 includes mass adjusting mesh holes 3107.

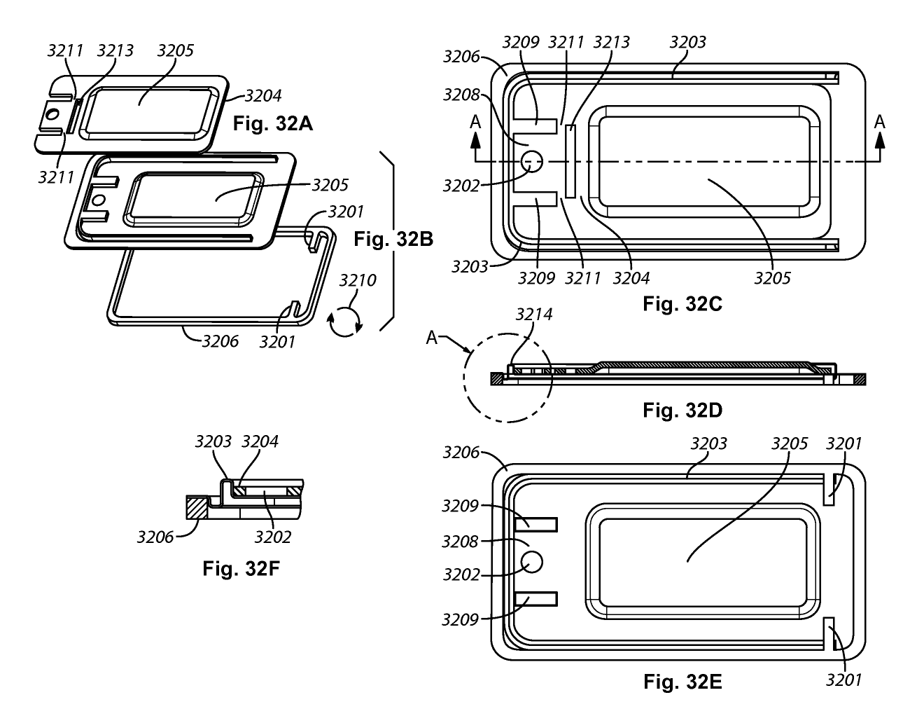

Referring now to FIGS. 32A-32F, another example of a diaphragm assembly 3200 is described. The diaphragm assembly 3200 includes torsional hinges 3201, a drive rod opening or hole 3202, a flexible membrane (annulus) 3203, a paddle 3204, a paddle stiffening member 3205, and a support member 3206. A gap 3212 is formed between portions of the support member 3206 and the paddle 3204. These elements are similar to those described above with respect to the example of FIGS. 2A-F. The example of FIGS. 32A-32F is different from the example of FIGS. 30A-F in that the membrane 3203 has an S-shaped portion 3214 in the gap 3212.

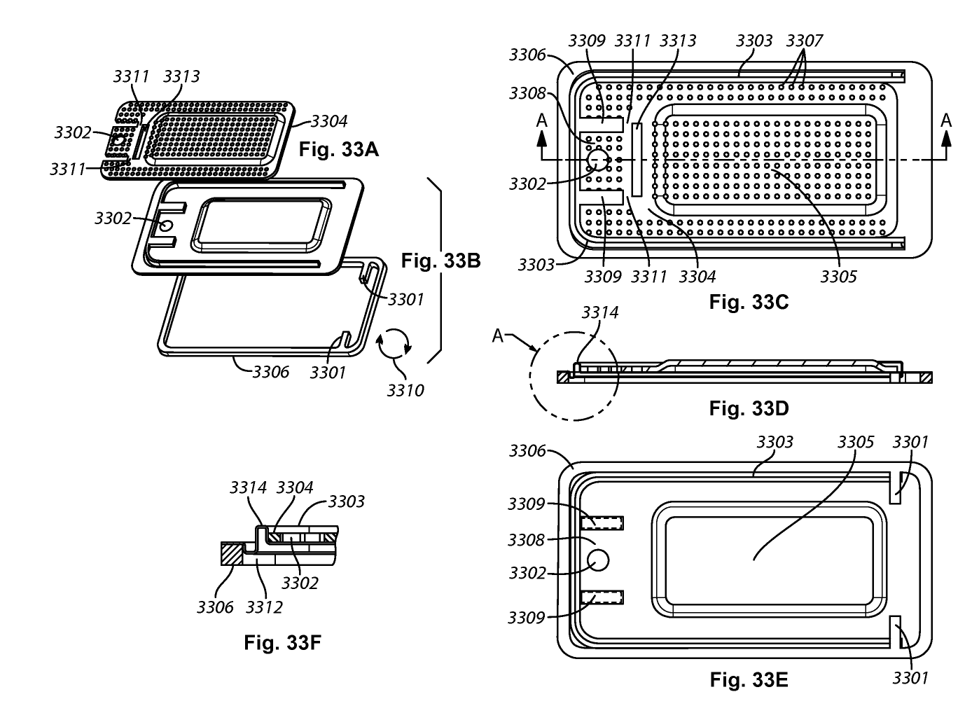

Referring now to FIGS. 33A-33F, another example of a diaphragm assembly 3300 is described. The diaphragm assembly 3300 includes torsional hinges 3301, a drive rod opening or hole 3302, a flexible membrane (annulus) 3303, a paddle 3304, a paddle stiffening member 3305, and a support member 3306. A gap 3312 is formed between portions of the support member 3306 and the paddle 3304. These elements are similar to those described above with respect to the example of FIGS. 2A-F. The example of FIGS. 33A-F is different from the example of FIGS. 32A-F in that the paddle 3304 includes mass adjusting mesh holes 3307.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. A diaphragm assembly disposed in a receiver, the assembly comprising:
a support structure, the support structure being generally rectangular and having a length that extends along a longitudinal axis, the support structure with a width that is generally perpendicular to the longitudinal axis, the length being greater than the width;
a paddle;
a membrane, the membrane extending over and being supported by the support structure and paddle;
a gap disposed between the paddle and the support structure;
a plurality of tabs extending across the gap and connecting the paddle and support structure, the tabs located along the length of the support structure and extending outward from the longitudinal axis across the gap;
wherein the tabs move in a twisting motion and not bending motion as the paddle moves.

2. The diaphragm assembly of claim 1, further comprising mesh openings extending through the paddle that are configured to adjust the mass of the paddle.

3. The diaphragm assembly of claim 1, wherein the membrane is configured in an S-shaped cross section where the membrane extends across the gap.

4. The diaphragm assembly of claim 1, comprising mesh openings extending through the paddle that are configured to adjust the mass of the paddle and wherein the membrane is configured in an S-shaped cross section where the membrane extends across the gap.

5. The diaphragm assembly of claim 1, wherein the paddle and support structure are constructed of different materials.

6. The diaphragm assembly of claim 1, wherein the paddle and the support structure are formed of multiple layers of materials.

7. The diaphragm assembly of claim 6, further comprising mesh openings extending through the paddle that are configured to adjust the mass of the paddle.

8. The diaphragm assembly of claim 1, further comprising a secondary paddle formed within the paddle.

9. The diaphragm assembly of claim 1, further comprising mesh openings extending through the secondary paddle that are configured to adjust the mass of the secondary paddle.

10. The diaphragm assembly of claim 9, wherein the membrane is configured in an S-shaped cross section where the membrane extends across the gap.

11. The diaphragm assembly of claim 1, wherein the membrane is configured in a U-shaped cross section where the membrane extends across the gap.

12. The diaphragm assembly of claim 1, further comprising a diaphragm stiffening member disposed on the paddle.

13. A receiver, the receiver comprising:
a coil;
a yoke;
at least one magnet coupled to the yoke;
an armature extending through the coil and between the magnets;
a diaphragm assembly;
a drive rod coupling the diaphragm assembly to the armature;
wherein the diaphragm assembly comprises:
a support structure, the support structure being generally rectangular and having a length that extends along a longitudinal axis, the support structure with a width that is generally perpendicular to the longitudinal axis, the length being greater than the width;
a paddle;
a membrane, the membrane extending over and being supported by the support structure and paddle;
a gap disposed between the paddle and the support structure;
a plurality of tabs extending across the gap and connecting the paddle and support structure, the tabs located along the length of the support structure and extending outward from the longitudinal axis across the gap;
wherein the tabs move in a twisting motion and not bending motion as the paddle moves.

14. The receiver of claim 13, further comprising mesh openings extending through the paddle that are configured to adjust the mass of the paddle.

15. The receiver of claim 13, wherein the membrane is configured in an S-shaped cross section where the membrane extends across the gap.

16. The receiver of claim 13, further comprising mesh openings extending through the paddle that are configured to adjust the mass of the paddle and wherein the membrane is configured in an S-shaped cross section where the membrane extends across the gap.

17. The receiver of claim 13, wherein the paddle and support structure are constructed of different materials.

18. The receiver of claim 13, wherein the paddle and the support structure are formed of multiple layers of materials.

19. The receiver of claim 18, further comprising mesh openings extending through the paddle that are configured to adjust the mass of the paddle.

20. The receiver of claim 13, further comprising a secondary paddle formed within the paddle.

21. The receiver of claim 13, further comprising mesh openings extending through the secondary paddle that are configured to adjust the mass of the secondary paddle.

22. The receiver of claim 22, wherein the membrane is configured in an S-shaped cross section where the membrane extends across the gap.

23. The receiver of claim 13, wherein the membrane is configured in a U-shaped cross section where the membrane extends across the gap.

24. The receiver of claim 13, further comprising a diaphragm stiffening member disposed on the paddle.
